(19) United States
(12) Patent Application Publication
(10) Pub. No.: US 2022/0309554 A1
(43) Pub. Date: Sep. 29, 2022

(54) GENERATING OUTPUT OBJECT FROM USER INPUTS OF MULTIPLE USERS

(71) Applicant: Taymour Semnani, Salt Lake City, UT (US)

(72) Inventor: Taymour Semnani, Salt Lake City, UT (US)

(21) Appl. No.: 17/656,829

(22) Filed: Mar. 28, 2022

Related U.S. Application Data
(60) Provisional application No. 63/166,419, filed on Mar. 26, 2021.
(60) Provisional application No. 63/251,554, filed on Oct. 1, 2021.

(51) Int. Cl. G06Q 30/06; G06Q 30/02

(52) U.S. Cl. CPC G06Q 30/0623; G06Q 30/0278

(57) ABSTRACT

A method for generating an output object for an item includes receiving, from a first user device of a first user, a first user input for a first aspect of an item; receiving, from a second user device of a second user, a second user input for the first aspect of the item; determining whether the first user input of the first user overlaps with the second user input of the second user; responsive to determining that the first user input of the first user overlaps with the second user input of the second user, determining an output value for the first aspect of the item based on the first user input of the first user and the second user input of the second user; and automatically generating an output object associated with the item, the output object including the output value of the first aspect of the item.

### BACKGROUND

The present disclosure relates to generating an output object from user inputs of multiple users.

In various contexts, multiple users may provide their inputs for an object and a value that satisfies all related users may be selected for the object. However, in existing systems, a user is usually aware of the inputs provided by other users and likely adjusts his or her own input accordingly. Additionally, human bias cannot be eliminated, so while using an intermediary to gather inputs will remove the bias and effects of the different users, the intermediary will still have their own bias that cannot be eliminated. Therefore, it is generally impractical and time-consuming for the existing systems to generate the object that satisfies all related users due to various adjustments back and forth and also removing all bias. Furthermore, because the user may evaluate viewpoint of other users based on their inputs for the object and vice versa, this existing solution usually causes negative impact on the potential collaboration between multiple users.

### SUMMARY

According to one innovative aspect of the subject matter in this disclosure, a method for generating an output object for an item is described. The method includes receiving, from a first user device associated with a first user, a first user input for a first aspect of an item; receiving, from a second user device associated with a second user, a second user input for the first aspect of the item; determining whether the first user input of the first user for the first aspect of the item overlaps with the second user input of the second user for the first aspect of the item; responsive to determining that the first user input of the first user for the first aspect of the item overlaps with the second user input of the second user for the first aspect of the item, determining an output value for the first aspect of the item based on the first user input of the first user and the second user input of the second user; and automatically generating an output object associated with the item, the output object including the output value of the first aspect of the item.

Implementations may include one or more of the following features. The method where automatically generating the output object associated with the item includes retrieving an object template of the output object associated with the item; and populating the object template of the output object with the output value of the first aspect of the item. The method where determining that the first user input of the first user overlaps with the second user input of the second user includes one or more of determining that the first user input of the first user matches the second user input of the second user, the first user input and the second user input being selected from a plurality of predefined inputs associated with the first aspect of the item; and determining that the first user input of the first user includes at least a portion of the second user input of the second user, the first user input and the second user input being a value range selected for the first aspect of the item. The method where determining the output value for the first aspect of the item includes determining a threshold value of the first user input for the first aspect of the item; determining a threshold value of the second user input for the first aspect of the item; computing a difference value between the threshold value of the first user input and the threshold value of the second user input; determining that the difference value between the threshold value of the first user input and the threshold value of the second user input satisfies a difference threshold; and computing the output value for the first aspect of the item based on the difference value and one or more of the threshold value of the first user input and the threshold value of the second user input. The method where determining the output value for the first aspect of the item includes determining a threshold value of the first user input for the first aspect of the item; determining a threshold value of the second user input for the first aspect of the item; computing a difference value between the threshold value of the first user input and the threshold value of the second user input; determining that the difference value between the threshold value of the first user input and the threshold value of the second user input does not satisfy a difference threshold; and computing, using a machine learning logic, the output value for the first aspect of the item based on an item context of the item, the threshold value of the first user input, and the threshold value of the second user input. The method where the item is one of a physical object, wherein an item context of the item describes one or more object features of the physical object; and an action between the first user and the second user, wherein the item context of the item describes a situation context of the action. The method that includes receiving an item context of the item, a first user profile of the first user, and a second user profile of the second user; receiving, from the first user device, one or more first flexibility metrics of the first user for one or more aspects of the item; receiving, from the second user device, one or more second flexibility metrics of the second user for the one or more aspects of the item; generating, using a machine learning logic, an input suggestion for the first aspect of the item based on the item context of the item, the first user profile of the first user, the second user profile of the second user, the one or more first flexibility metrics of the first user, and the one or more second flexibility metrics of the second user; and transmitting, to the first user device and the second user device for displaying to the first user and the second user, the input suggestion for the first aspect of the item. The method that includes responsive to determining that the first user input of the first user for the first aspect of the item does not overlap with the second user input of the second user for the first aspect of the item, determining, using a machine learning logic, a second aspect of the item based on the first aspect of the item; receiving, from the first user device, a third user input of the first user for the first aspect of the item and a fourth user input of the first user for the second aspect of the item; receiving, from the second user device, a fifth user input of the second user for the first aspect of the item and a sixth user input of the second user for the second aspect of the item; determining that the third user input of the first user for the first aspect of the item overlaps with the fifth user input of the second user for the first aspect of the item, and the fourth user input of the first user for the second aspect of the item overlaps with the sixth user input of the second user for the second aspect of the item; determining a different output value for the first aspect of the item based on the third user input of the first user and the fifth user input of the second user; determining an output value for the second aspect of the item based on the fourth user input of the first user and the sixth user input of the second user; and automatically generating the output object associated with the item, the output object including the different output value of the first aspect of the item and the output value for the second aspect of the item. The method that includes generating, using another machine learning logic, an input suggestion for the second aspect of the item based on an input suggestion for the first aspect of the item; and transmitting, to the first user device and the second user device for displaying to the first user and the second user, the input suggestion for the second aspect of the item, wherein the first user device and the second user device displays the input suggestion for the second aspect of the item together with the input suggestion for the first aspect of the item.

Generally another innovative aspect of the subject matter described in this disclosure may be embodied in a system that includes one or more processors; and one or more memories storing instructions that, when executed by the one or more processors, cause the system to perform operations including receiving, from a first user device associated with a first user, a first user input for a first aspect of an item, receiving, from a second user device associated with a second user, a second user input for the first aspect of the item, determining whether the first user input of the first user for the first aspect of the item overlaps with the second user input of the second user for the first aspect of the item, responsive to determining that the first user input of the first user for the first aspect of the item overlaps with the second user input of the second user for the first aspect of the item, determining an output value for the first aspect of the item based on the first user input of the first user and the second user input of the second user, and automatically generating an output object associated with the item, the output object including the output value of the first aspect of the item.

Generally another innovative aspect of the subject matter described in this disclosure may be embodied in a method that includes receiving, at a computing device from a first user device, a first value range for a first aspect of an item, the first user device being associated with a first user and distinct from the computing device; receiving, at the computing device from a second user device, a second value range for the first aspect of the item, the second user device being associated with a second user and distinct from the computing device; determining, at the computing device, an overlap range between a threshold value of the first value range and a threshold value of the second value range; determining, at the computing device, an output value in the overlap range for the first aspect of the item based on the threshold value of the first value range and the threshold value of the second value range; and transmitting, from the computing device to the first user device and the second user device, the output value of the first aspect of the item.

Implementations may include one or more of the following features. The method where the output value in the overlap range for the first aspect of the item satisfies a predefined ratio relative to the threshold value of the first value range and the threshold value of the second value range that are associated with the overlap range. The method where determining the output value in the overlap range for the first aspect of the item includes determining that the overlap range does not satisfy a difference threshold; and computing, using a machine learning logic, the output value in the overlap range for the first aspect of the item based on an item context of the item, the threshold value of the first value range, and the threshold value of the second value range. The method that includes receiving an item context of the item, a first user profile of the first user, and a second user profile of the second user; receiving, from the first user device, one or more first flexibility metrics of the first user for one or more aspects of the item; receiving, from the second user device, one or more second flexibility metrics of the second user for the one or more aspects of the item; generating, using a machine learning logic, a value range suggestion for the first aspect of the item based on the item context of the item, the first user profile of the first user, the second user profile of the second user, the one or more first flexibility metrics of the first user, and the one or more second flexibility metrics of the second user; and transmitting, to the first user device and the second user device for displaying to the first user and the second user, the value range suggestion for the first aspect of the item.

Other implementations of one or more of these aspects and other aspects described in this document include corresponding systems, apparatus, and computer programs, configured to perform the actions of the methods, encoded on computer storage devices. The above and other implementations are advantageous in a number of respects as articulated through this document. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of an example system for generating an output object from user inputs.

FIG. 2 is a block diagram of an example processing agent.

FIGS. 3A and 3B illustrate a flowchart of an example method for generating an output object from user inputs.

FIG. 4 is a flowchart of an example method for generating an input suggestion.

FIGS. 5A, 5B and 5C illustrate a flowchart of an example method for generating an output object from user inputs.

FIG. 6 is a flowchart of an example method for computing an output value for an aspect of an output object.

FIGS. 7A, 7B and 7C illustrate a first user input of a first user relative to a second user input of a second user.

FIG. 8 is a flowchart of an example method for facilitating an offer for a good or service.

### DETAILED DESCRIPTION

The technology described herein can automatically generate an output object from user inputs of multiple users. The output object may include output values associated with various aspects of the object in which the output values may satisfy all multiple users and/or the multiple users may be required to comply with the output object, such as by a legally binding contract, etc. Non-limiting examples of the output object include a legal document, a contract document, a settlement agreement, etc. Other types of output object are also possible and contemplated.

As described in further detail below, the present technology includes methods and systems that implement a processing agent. The processing agent may receive from a first user device of a first user a first user input for a first aspect of an item, and receive from a second user device of a second user a second user input for the same first aspect of the same item. In some embodiments, the item may be a physical object (e.g., a house, a vehicle, etc.), an action between the first user and the second user (e.g., a litigating action, a hiring action, an ownership transaction, a settlement offer, etc.), and/or other types of item for which the first user and the second user may cooperate to generate an output object associated with the item. As discussed elsewhere herein, the first user and the second user may be bound to comply with the output object, such as by a legally binding agreement that is entered into at the beginning of the process and applies to the multiple users, etc. In some embodiments, the processing agent may determine whether the first user input of the first user overlaps with the second user input of the second user. For example, depending on an input type of the first user input and the second user input, the processing agent may determine whether the first user input matches the second user input or whether the first user input includes at least a portion of the second user input.

In some embodiments, if the first user input of the first user overlaps with the second user input of the second user, the processing agent may determine an output value for the first aspect of the item based on the first user input of the first user and the second user input of the second user. For example, in some implementations, the processing agent may apply a machine learning logic on a threshold value of the first user input (e.g., a lower limit of the first user input), a threshold value of the second user input (e.g., an upper limit of the second user input), an item context of the item, etc., to determine the output value for the first aspect of the item. Various implementations for determining the output value of the first aspect of the item are described in detail elsewhere herein. In some embodiments, once the output value of the first aspect of the item is determined, the processing agent may automatically generate the output object associated with the item in which the output object may include the output value of the first aspect of the item. Alternatively, if the output object associated with the item was already created, the processing agent may update the output object to include the output value of the first aspect of the item.

In some embodiments, if the first user input of the first user does not overlap with the second user input of the second user, the processing agent may transmit an input disparity notification to the first user device of the first user and the second user device of a second user. In this situation, the first user and/or the second user may provide a different first user input and/or a different second user input for the first aspect of the item in another attempt to determine an output value for the first aspect of the item that satisfies both the first user and the second user. In some embodiments, the processing agent may use a machine learning logic to determine a second aspect of the item based on the first aspect of the item. In this situation, each of the first user and the second user may provide a user input for the second aspect of the item and a different user input for the first aspect of the item. As the first user and the second user may consider the first aspect of the item together with the second aspect of the item, the likelihood of the user inputs provided by the first user and the second user for these aspects satisfying both the first user and the second user may be increased.

In some embodiments, if the user inputs provided by the first user and the second user for the first aspect of the item overlap with one another and the user inputs provided by the first user and the second user for the second aspect of the item also overlap with one another, the processing agent may determine an output value for the first aspect of the item based on the user inputs of the first user and the second user for the first aspect of the item, and determine an output value for the second aspect of the item based on the user inputs of the first user and the second user for the second aspect of the item. In some embodiments, the processing agent may automatically generate the output object associated with the item in which the output object may include the output value of the first aspect of the item and the output value of the second aspect of the item. Alternatively, if the output object associated with the item was already created, the processing agent may update the output object to include the output value of the first aspect of the item and the output value of the second aspect of the item.

In some embodiments, to facilitate the first user and the second user in providing their user input for the first aspect of the item, the processing agent may generate an input suggestion for the first aspect of the item based on various factors using a machine learning logic, and transmit the input suggestion for the first aspect of the item to the first user device and the second user device to display to the first user and the second user. In some embodiments, to facilitate the first user and the second user in providing their user input for the second aspect of the item together with their user input for the first aspect of the item as discussed above, the processing agent may generate an input suggestion for the second aspect of the item based on the input suggestion for the first aspect of the item and various factors using another machine learning logic, and transmit the input suggestion for the second aspect of the item to the first user device and the second user device. The first user device and the second user device may display the input suggestion for the second aspect of the item together with the input suggestion for the first aspect of the item to the first user and the second user. In some embodiments, the factors being used to generate the input suggestion for the first aspect and/or the second aspect of the item may include an item context of the item, flexibility metrics of the first user and the second user corresponding to each aspect of the item, user profiles of the first user and the second user, etc.

As discussed elsewhere herein, the item may be a physical object, and the item context of the item may describe one or more object features of the physical object. Alternatively, the item may be an action between the first user and the second user, and the item context of the item may describe a situation context of the action. As discussed elsewhere herein, the flexibility metric of a user corresponding to an aspect of the item may indicate a flexibility or a willingness of the user in adjusting his or her user input for the aspect of the item. As discussed elsewhere herein, the user profile of the user may describe a value pattern of the user inputs that were provided, adjusted, and/or approved by the user for different aspects of different items. In some embodiments, the user profile of the user may be determined from historical data associated with various user sessions in which the user and one or more other users may provide their user inputs for different items to generate output objects for these items that are mutually complied with by the user and the one or more other users. Providing input suggestions for the first aspect and/or the second aspect of the item to the first user and the second user is advantageous, because it increases the likelihood that the user inputs provided by the first user and the second user for the first aspect and/or the second aspect of the item satisfy both the first user and the second user.

The technology described herein is advantageous in a number of respects. For example, as the user inputs of the first user and the second user for an aspect of the item are transmitted to the processing agent, the first user and the second user may not be aware of the user input provided by one another. As a result, the first user may not subjectively adjust his or her user input based on the user input of the second user and vice versa. Therefore, the output object for the item may be generated in an expedited manner without multiple subjective adjustments of the user inputs by the related users. In some embodiments, the related users may include the first user, the second user, and/or other users that provides his or her user inputs for various aspects of the item and are bound to comply with the output object associated with the item. Furthermore, once the user inputs of the first user and the second user for the aspects of the item are provided, the processing agent may compute the output value for the aspects of the item and automatically generate the output object including the output values for the item substantially in real-time, thereby reducing the delay in generating the output object for the item. In addition, as the first user and the second user may not be aware of the user input provided by one another, the first user may not be informed of the viewpoint or the evaluation of the second user for the item and vice versa. This implementation may prevent the viewpoint or the evaluation of each user for the item being used against himself or herself in the collaboration between the first user and the second user to generate the output object mutually complied with by the first user and the second user.

In further implementations, the processing agent may compute the various output values in place of a human mediator receiving information from the respective users. A human mediator would have an implicit bias that cannot be eliminated when information is being received from the respective users and this implicit bias may affect the mediator's determinations and suggestions. The processing agent is advantageous in that it has no implicit bias and can fairly and equitably receive the information from the respective users and objectively generate the output values for the item or dispute without being affected by a bias. In this implementation, it has been shown that it is impossible to remove implicit bias from a human receiving information and the processing agent is able to objectively perform the task in a way that a human mediator is unable to do.

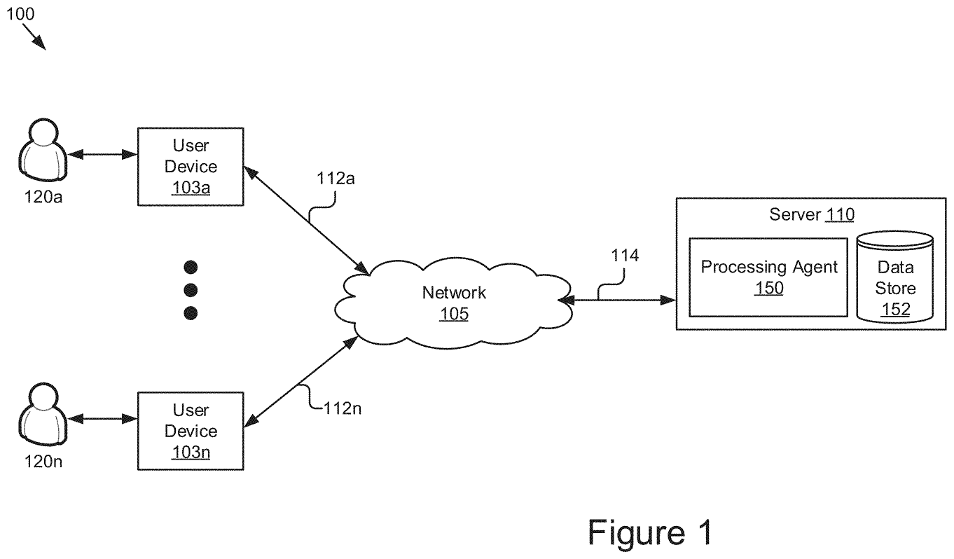

FIG. 1 is a block diagram of an example system 100 for generating an output object from user inputs of multiple users. As shown, the system 100 includes a server 110 and one or more user devices 103a . . . 103n associated with one or more users 120a . . . 120n. The servers 110 and the one or more user devices 103a . . . 103n may be coupled for electronic communication via a network 105. In FIG. 1 and the remaining figures, a letter after a reference number, e.g., “103a,” represents a reference to the element having that particular reference number. A reference number in the text without a following letter, e.g., “103,” represents a general reference to instances of the element bearing that reference number. It should be understood that the system 100 depicted in FIG. 1 is provided by way of example and the system 100 and/or further systems contemplated by this present disclosure may include additional and/or fewer components, may combine components and/or divide one or more of the components into additional components, etc. For example, the system 100 may include any number of user devices 103, networks 105, or servers 110.

The network 105 may be a conventional type, wired and/or wireless, and may have numerous different configurations including a star configuration, token ring configuration, or other configurations. For example, the network 105 may include one or more local area networks (LAN), wide area networks (WAN) (e.g., the Internet), personal area networks (PAN), public networks, private networks, virtual networks, virtual private networks, peer-to-peer networks, near field networks (e.g., Bluetooth®, NFC, etc.), vehicular networks, and/or other interconnected data paths across which multiple devices may communicate.

The network 105 may also be coupled to or include portions of a telecommunications network for sending data in a variety of different communication protocols. Example protocols include, but are not limited to, transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other suitable protocols. In some embodiments, the network 105 is a wireless network using a connection such as DSRC (Dedicated Short Range Communication), WAVE, 802.11p, a 3G, 4G, 5G+network, WiFi™, satellite networks, or any other wireless networks. Although FIG. 1 illustrates a single block for the network 105 that couples to the server 110 and the user device(s) 103, it should be understood that the network 105 may in practice comprise any number of combination of networks, as noted above.

The user device 103 may be a computing device that includes a processor, a memory, and network communication capabilities (e.g., a communication unit). The user device 103 may be coupled to the network 105, as reflected by signal line 112. In some embodiments, the user device 103 may send and receive data to and from other entities of the system 100 (e.g., the server 110, other user devices 103, etc.). Non-limiting examples of the user device 103 include, but are not limited to, a desktop computer, laptop computer, holographic computer, tablet, mobile phone, personal digital assistant (PDA), etc. In some embodiments, the user device 103 may receive user inputs from a user 120 associated with the user device 103 and/or display various data to the user 120 via input/output components of the user device 103 (e.g., display screen, touch screen, mouse, keyboard, etc.). As an example, the user device 103 may display to the user 120 an input suggestion for an aspect of an item on its touch screen, and the user 120 may use the touch screen to provide his or her user input for the aspect of the item.

The server 110 includes a hardware and/or virtual server that includes a processor, a memory, and network communication capabilities (e.g., a communication unit). The server 110 may be communicatively coupled to the network 105, as reflected by signal line 114. In some embodiments, the server 110 may send and receive data to and from other entities of the system 100 (e.g., one or more user devices 103). As depicted, the server 110 may include an instance of a processing agent 150 and a data store 152 that stores various types of data for access and/or retrieval by this application. For example, the data store 152 may store user data associated with various users 120. For a first user 120, the user data may include a user identifier (ID) uniquely identifying the first user 120, a user profile of the first user 120, one or more flexibility metrics of the first user 120 corresponding to one or more aspects of various items, etc. In some embodiments, the user profile of the first user 120 may describe a value pattern of the user inputs that were provided, adjusted, and/or approved by the first user 120 for different aspects of different items. Such value pattern may be determined from historical data associated with various user sessions in which the first user 120 and one or more other users may provide their user inputs for different items to negotiate output objects for these items that are mutually complied with by the first user 120 and the one or more other users. In some embodiments, the flexibility metric of the first user 120 corresponding to an aspect of an item may indicate a flexibility or a willingness of the first user 120 in adjusting his or her output value for the aspect of the item. Such flexibility metric may be specified by the first user 120. Other types of user data are also possible and contemplated.

In some embodiments, the data store 152 may store item data associated with various items, etc. In some embodiments, the item data of a first item may include an item ID uniquely identifying the first item, an item type of the first item (e.g., physical object, interaction between two or more users, etc.), an item context of the first item, etc. In some embodiments, if the first item is a physical object (e.g., a house), the item context may describe various object features of the physical object (e.g., house address, year built, home type, number of bedrooms, number of bathrooms, etc.). In some embodiments, if the first item is an action between two or more users (e.g., a hiring action between a first user and a second user), the item context may describe situation context of the action (e.g., job description, candidate qualifications, etc.). Other types of item data are also possible and contemplated.

Other variations and/or combinations are also possible and contemplated. It should be understood that the system 100 illustrated in FIG. 1 is representative of an example system and that a variety of different system environments and configurations are contemplated and are within the scope of the present disclosure. For example, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Furthermore, various entities of the system may be integrated into a single computing device or system or divided into additional computing devices or systems, etc.

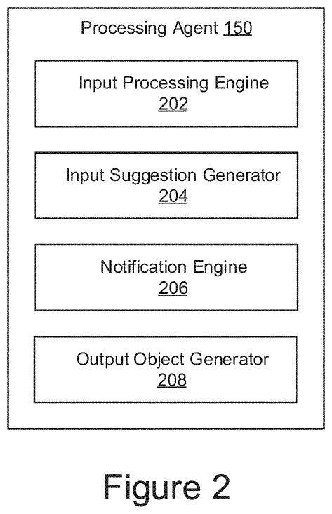

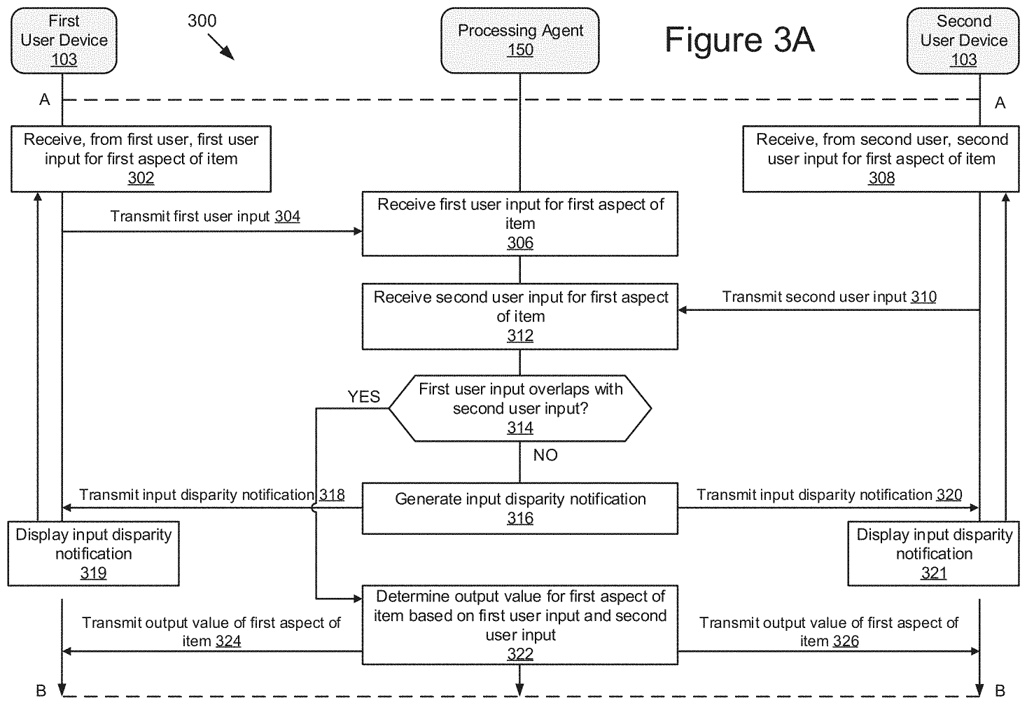

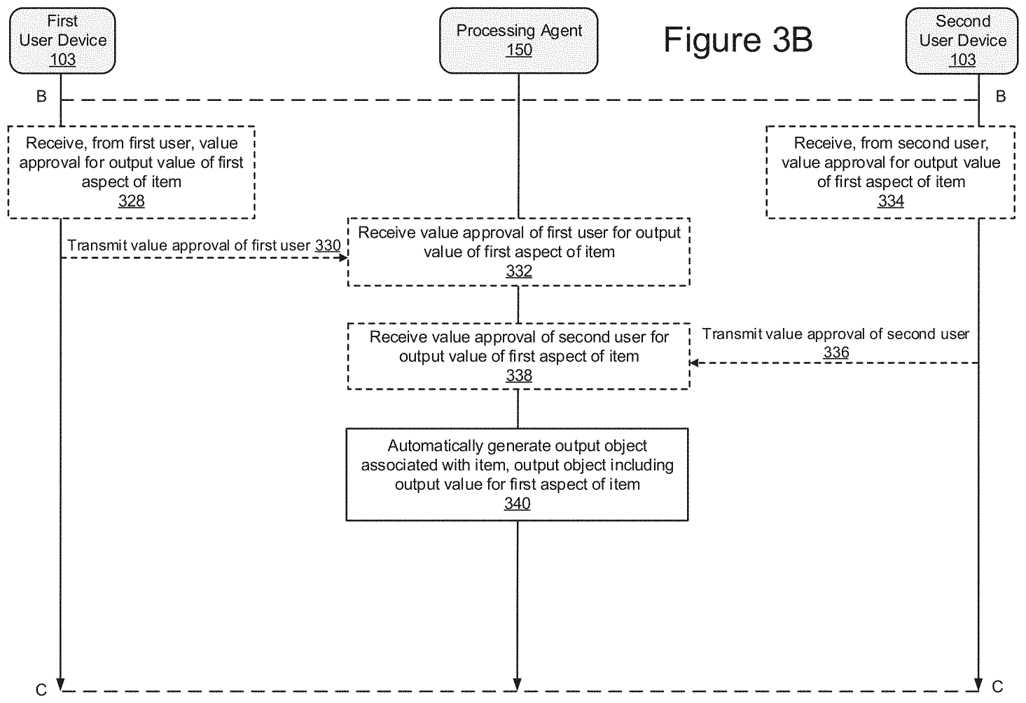

FIG. 2 is a block diagram of an example processing agent 150. As depicted, the processing agent 150 may include an input processing 202, an input suggestion generator 204, a notification engine 206, and an output object generator 208, although it should be understood that the processing agent 150 may include additional components such as, but not limited to, a configuration engine, a training engines, an encryption/decryption engine, etc., and/or these various components may be combined into a single engine or divided into additional engines. In some embodiments, the input processing 202, the input suggestion generator 204, the notification engine 206, and the output object generator 208 may be implemented as software, hardware, or a combination of the foregoing. In some embodiments, the input processing 202, the input suggestion generator 204, the notification engine 206, and the output object generator 208 may be communicatively coupled by a bus and/or a processor to one another and/or to other components of a computing device on which the processing agent 150 is implemented (e.g., the user device 103, the server 110, etc.). In some embodiments, one or more of the components 103, 202, 204, 206, and/or 208 are sets of instructions executable by the processor to provide their functionality. In some embodiments, one or more of the components 103, 202, 204, 206, and/or 208, are storable in a memory and are accessible and executable by the processor to provide their functionality. In any of the foregoing embodiments, these components 103, 202, 204, 206, and/or 208 may be adapted for cooperation and communication with the processor and other components of the computing device on which the processing agent 150 is implemented. The processing agent 150, and its components 103, 202, 204, 206, and/or 208 are described in further detail below with reference to at least FIGS. 3A-7C.

FIGS. 3A and 3B illustrate a flowchart of an example method 300 for generating an output object from user inputs provided by a first user 120 and a second user 120. As depicted, the method 300 may be performed by a first user device 103 associated with the first user 120, a second user device 103 associated with the second user 120, and the processing agent 150 implemented in the server 110. In block 302, the first user device 103 may receive from the first user 120 a first user input for a first aspect of an item. In block 304, the first user device 103 may transmit the first user input of the first user 120 for the first aspect of the item to the processing agent 150. In some embodiments, the item may be a physical object (e.g., a house, a vehicle, etc.) or an action between the first user 120 and the second user 120 (e.g., a litigating action, a hiring action, an ownership transaction, a settlement, etc.) for which the first user 120 and the second user 120 may provide their user inputs to negotiate an output object related to the item. In some embodiments, the item may include multiple aspects, and the first user 120 and the second user 120 may provide their user inputs for one or more aspects of the item to determine the output values for these aspects that satisfy both the first user 120 and the second user 120. In some embodiments, the output values of these aspects may be included in the output object with which the first user 120 and the second user 120 are required to comply.

As a first example, the item may be a litigation action between the first user 120 and the second user 120 in a lawsuit, and the aspects of the item may include a settlement amount (e.g., monetary amount to settle the lawsuit), sentencing time, duration of restraining order, etc. As a second example, the item may be a house, and the aspects of the item may include a selling price, home insurance coverage, included home appliances, included remodeled areas, etc. As a third example, the item may be a hiring action between the first user 120 and the second user 120 in a recruitment process of an entity, and the aspects of the item may include salary amount, vacation time, one or more benefit options (e.g., health insurance, retirement contribution, etc.), etc. Other examples of the item and aspects of the item are also possible and contemplated. In the first example, for the item that is the litigation action between the first user 120 and the second user 120, the first user device 103 may receive a first user input in the form of a value range [$200,000-$350,000] from the first user 120 for the first aspect “settlement amount” of the item.

In block 308, the second user device 103 may receive from the second user 120 a second user input for the first aspect of the item. In block 310, the second user device 103 may transmit the second user input of the second user 120 for the first aspect of the item to the processing agent 150. Continuing the first example, for the item that is the litigation action between the first user 120 and the second user 120, the second user device 103 may receive a second user input in the form of a value range [such as $320,000-$500,000] from the second user 120 for the first aspect “settlement amount” of the item.

In block 306, the processing agent 150 may receive the first user input of the first user 120 for the first aspect of the item from the first user device 103. In block 312, the processing agent 150 may receive the second user input of the second user 120 for the first aspect of the item from the second user device 103. Thus, the processing agent 150 may receive the first user input of the first user 120 and the second user input of the second user 120 for the same first aspect of the same item.

In block 314, the processing agent 150 may determine whether the first user input of the first user 120 for the first aspect of the item overlaps with the second user input of the second user 120 for the first aspect of the item. To determine whether the first user input of the first user 120 overlaps with the second user input of the second user 120, the input processing engine 202 of the processing agent 150 may determine an input type of the first user input and the second user input. If the first user input and the second user input are predefined inputs that are selected from a plurality of predefined inputs associated with the first aspect of the item (e.g., binary input, multiple-choice input, etc.), the input processing engine 202 may determine whether the first user input of the first user 120 matches the second user input of the second user 120. For example, the input processing engine 202 may determine whether the first user input of the first user 120 is the same as the second user input of the second user 120. Alternatively, if the first user input and the second user input are value ranges that the first user 120 and the second user 120 selected for the first aspect of the item, the input processing engine 202 may determine whether the first user input of the first user 120 includes at least a portion of the second user input of the second user 120. For example, the input processing engine 202 may determine whether the value range provided by the first user 120 includes one or more values that are within the value range provided by the second user 120.

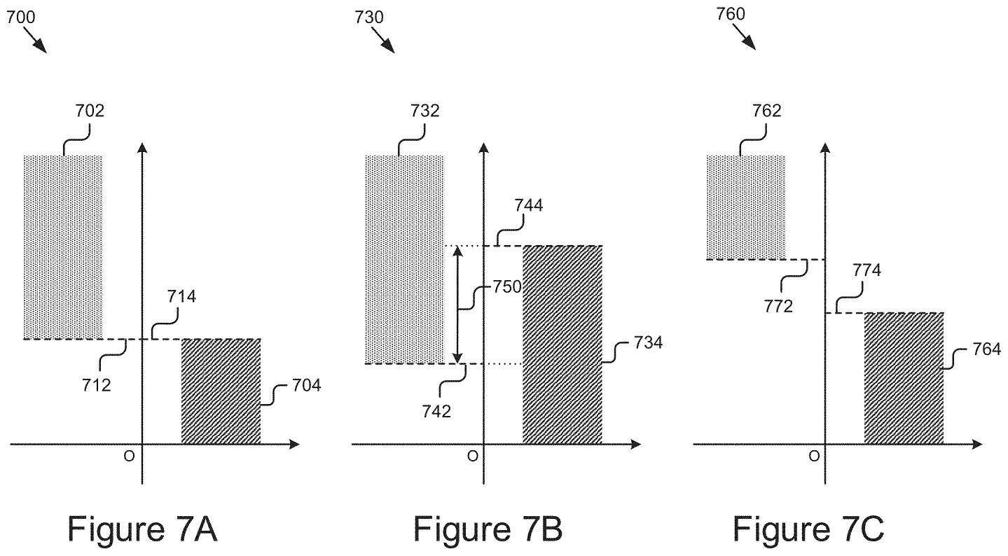

FIGS. 7A-7C illustrate different scenarios of the first user input of the first user 120 relative to the second user input of the second user 120 in which the first user input and the second user input are value range inputs. As depicted, in scenario 700 in FIG. 7A, the first value range 702 input by the first user 120 may include the value 712 that is within the second value range 704 input by the second user 120. In this example, the first value range 702 and the second value range 704 may have only one value in common that is the lower limit 712 of the first value range 702 being equal to the upper limit 714 of the second value range 704. In scenario 730 in FIG. 7B, the first value range 732 input by the first user 120 and the second value range 734 input by the second user 120 may have multiple values in common. These multiple values may be within both the first value range 732 and the second value range 734 and may form an overlap range located between the threshold value of the first value range 732 and the threshold value of the second value range 734. In this example, the overlap range 750 is located between the lower limit 742 of the first value range 732 and the upper limit 744 of the second value range 734. In scenario 760 in FIG. 7C, the first value range 762 input by the first user 120 may not include any value that is within the second value range 764 input by the second user 120. In this example, the lower limit 772 of the first value range 762 is higher than the upper limit 774 of the second value range 764, and the first value range 762 and the second value range 764 do not overlap.

If in block 314, the processing agent 150 determines that the first user input of the first user 120 for the first aspect of the item overlaps with the second user input of the second user 120 for the first aspect of the item, the method 300 may proceed to block 322. In block 322, the processing agent 150 may determine an output value for the first aspect of the item based on the first user input of the first user 120 and the second user input of the second user 120. In some embodiments, to determine the output value for the first aspect of the item, if the first user input of the first user 120 matches the second user input of the second user 120, the input processing engine 202 of the processing agent 150 may determine the output value for the first aspect of the item to be the first user input matching the second user input. Continuing the first example, for the item that is the litigation action between the first user 120 and the second user 120, the input processing engine 202 may determine the output value for the aspect “whether settlement payment includes tangible assets” of the item to be “no.”

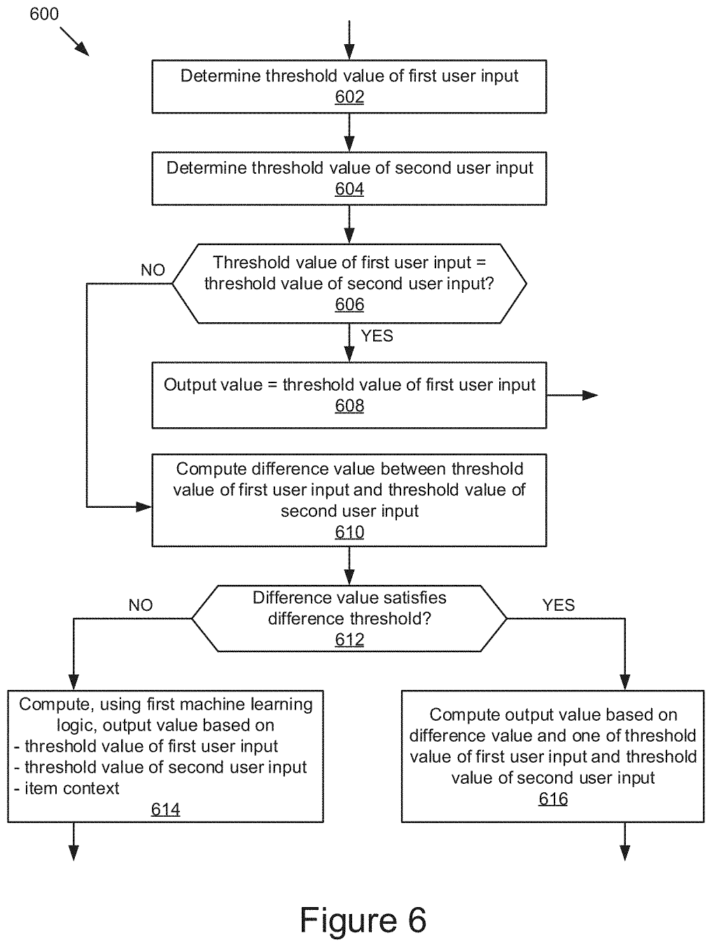

FIG. 6 is a flowchart of an example method 600 for computing an output value for the first aspect of the item in which the first user input of the first user 120 and the second user input of the second user 120 for the first aspect of the item are value range inputs and overlap with one another. In block 602, the input processing engine 202 may determine a threshold value of the first user input provided by the first user 120 for the first aspect of the item. For example, the input processing engine 202 may determine the upper limit and/or the lower limit of the first user input of the first user 120. In block 604, the input processing engine 202 may determine a threshold value of the second user input provided by the second user 120 for the first aspect of the item. For example, the input processing engine 202 may determine the upper limit and/or the lower limit of the second user input of the second user 120.

In block 606, the input processing engine 202 may determine whether the threshold value of the first user input of the first user 120 equals to the threshold value of the second user input of the second user 120. If the threshold value of the first user input of the first user 120 equals to the threshold value of the second user input of the second user 120, the method 600 may proceed to block 608. In block 608, the input processing engine 202 may determine the output value for the first aspect of the item to be the threshold value of the first user input of the first user 120 that is equal to the second user input of the second user 120. For example, in scenario 700 in FIG. 7A, the input processing engine 202 may determine the output value for the first aspect of the item to be the lower limit 712 of the first value range 702 provided by the first user 120 that is equal to the upper limit 714 of the second value range 704 provided by the second user 120.

If in block 606, the input processing engine 202 determines that the threshold value of the first user input of the first user 120 does not equal to the threshold value of the second user input of the second user 120, method 600 may proceed to block 610. In block 610, the input processing engine 202 may compute a difference value between the threshold value of the first user input of the first user 120 and the threshold value of the second user input of the second user 120. For example, in scenario 730 in FIG. 7B, the input processing engine 202 may determine the difference value between the lower limit 742 of the first value range 732 provided by the first user 120 and the upper limit 744 of the second value range 734 provided by the second user 120. The difference value may correspond to the overlap range 750 located between the lower limit 742 of the first value range 732 and the upper limit 744 of the second value range 734.

In block 612, the input processing engine 202 may determine whether the difference value between the threshold value of the first user input and the threshold value of the second user input satisfies a difference threshold (e.g., less than $25,000). If the difference value between the threshold value of the first user input and the threshold value of the second user input satisfies the difference threshold, the input processing engine 202 may determine that the first user input and the second user input that the first user 120 and the second user 120 provided for the first aspect of the item are not too different from one another. The method 600 may then proceed to block 616. In block 616, the input processing engine 202 may compute the output value for the first aspect of the item based on the difference value and one or more of the threshold value of the first user input and the threshold value of the second user input. In some embodiments, the input processing engine 202 may compute the output value in the overlap range corresponding to the difference value, and the output value may satisfy a predefined ratio relative to the threshold value of the first user input and the threshold value of the second user input that are associated with the overlap range.

As an example, in scenario 730 in FIG. 7B, the input processing engine 202 may determine the output value for the first aspect of the item in the overlap range 750 corresponding to the difference value between the threshold value of the first value range 732 provided by the first user 120 and the threshold value of the second value range 734 provided by the second user 120. In this example, the output value may divide the overlap range 750 by a predefined ratio of (50%:50%), and therefore the distance between the output value and the threshold value of the first value range 732 that is associated with the overlap range 750 (e.g., the lower limit 742 of the first value range 732) may be equal to the distance between the output value and the threshold value of the second value range 734 that is associated with the overlap range 750 (e.g., the upper limit 744 of the second value range 734). Thus, in this example, because the lower limit 742 of the first value range 732 provided by the first user 120 is not too different from the upper limit 744 of the second value range 734 provided by the second user 120, the input processing engine 202 may determine the output value for first aspect of the item to be at a midpoint between the lower limit 742 input by the first user 120 and the upper limit 744 input by the second user 120. It should be understood that other predefined ratio relative to the threshold value of the first user input and the threshold value of the second user input are also possible and contemplated (e.g., (75%:25%), (25%:75%), etc.).

If in block 612, the input processing engine 202 determines that the difference value between the threshold value of the first user input and the threshold value of the second user input does not satisfy the difference threshold (e.g., less than $25,000), the input processing engine 202 may determine that the first user input and the second user input that the first user 120 and the second user 120 provided for the first aspect of the item are relatively different from one another. The method 600 may then proceed to block 614. In block 614, the input processing engine 202 may compute the output value for the first aspect of the item based on the item context of the item, the threshold value of the first user input provided by the first user 120 for the first aspect of the item, the threshold value of the second user input provided by the second user 120 for the first aspect of the item, etc., using a first machine learning logic. In some embodiments, the input processing engine 202 may apply the first machine learning logic to the item context of the item, the threshold value of the first user input, the threshold value of the second user input, etc., to determine the output value for the first aspect of the item. In some embodiments, the first machine learning logic may be trained using multiple datasets associated with multiple user sessions in which various users may provide their user inputs for various items to negotiate the output objects for these items. Thus, from these multiple datasets, the first machine learning logic may learn to compute a fair and reasonable output value for a particular aspect of an item that likely satisfies the related users given the item context of the item, the user inputs provided by the related users for the particular aspect of the item, and/or other factors.

Referring back to FIGS. 3A and 3B, once the output value for the first aspect of the item is determined, in block 324, the input processing engine 202 of the processing agent 150 may transmit the output value of the first aspect of the item to the first user device 103. The first user device 103 may display the output value of the first aspect of the item to the first user 120 via the input/output components of the first user device 103. In block 328, the first user device 103 may receive from the first user 120 a value approval for the output value of the first aspect of the item via the input/output components of the first user device 103. In block 330, the first user device 103 may transmit the value approval of the first user 120 for the output value of the first aspect of the item to the processing agent 150. Similarly, in block 326, the input processing engine 202 may transmit the output value of the first aspect of the item to the second user device 103. The second user device 103 may display the output value of the first aspect of the item to the second user 120 via the input/output components of the second user device 103. In block 334, the second user device 103 may receive from the second user 120 a value approval for the output value of the first aspect of the item via the input/output components of the second user device 103. In block 336, the second user device 103 may transmit the value approval of the second user 120 for the output value of the first aspect of the item to the processing agent 150.

In block 332, the processing agent 150 may receive the value approval of the first user 120 for the output value of the first aspect of the item from the first user device 103. In block 338, the processing agent 150 may receive the value approval of the second user 120 for the output value of the first aspect of the item from the second user device 103. Thus, the processing agent 150 may receive the value approval of the first user 120 and the value approval of the second user 120 for the output value of the first aspect of the item. In block 340, the processing agent 150 may automatically generate the output object associated with the item, the output object may include the output value of the first aspect of the item. In some embodiments, to generate the output object, the output object generator 208 of the processing agent 150 may retrieve an object template of the output object associated with the item from the data store 152, and populate the object template of the output object with the output value of the first aspect of the item. Alternatively, if the output object associated with the item was previously created, the output object generator 208 may retrieve the output object associated with the item, and update the output object associated with the item to include the output value of the first aspect of the item. Non-limiting examples of the output object include a legal document, a contract document, a settlement document, a sale agreement document, etc. Other types of output object are also possible and contemplated.

In some embodiments, the operations in blocks 328, 330, 332, 334, 336, 338 of the method 300 may be optional. For example, in some embodiments, the first user device 103 and the second user device 103 may not receive the value approval of the first user 120 and/or the second user 120 for the output value of the first aspect of the item, and therefore the processing agent 150 may not receive these value approvals from the first user device 103 of the first user 120 and/or the second user device 103 of the second user 120. Thus, the processing agent 150 may automatically generate the output object including the output value of the first aspect of the item without the explicit approvals of the first user 120 and the second user 120 for the output value of the first aspect of the item. In these embodiments, once the first user 120 and the second user 120 provide their user input for the first aspect of the item, if their user inputs for the first aspect of the item overlap and an output value for the first aspect of the item can be computed based on their user inputs as discussed above, such output value may be considered as automatically accepted by the first user 120 and the second user 120 and may be automatically included in the output object that the first user 120 and the second user 120 are required to comply with. This implementation is advantageous, because it can reduce the amount of communication between the user devices 103 and the processing agent 150 as well as prevent subjective adjustments of the user inputs by the first user 120 and the second user 120 in case there is already an output value satisfying their original user inputs. In addition, once the first user 120 and the second user 120 provide their user inputs for the first aspect of the item, the processing agent 150 can compute the output value for the first aspect of the item substantially in real-time, thereby significantly reducing the delay in generating the output object associated with the item.

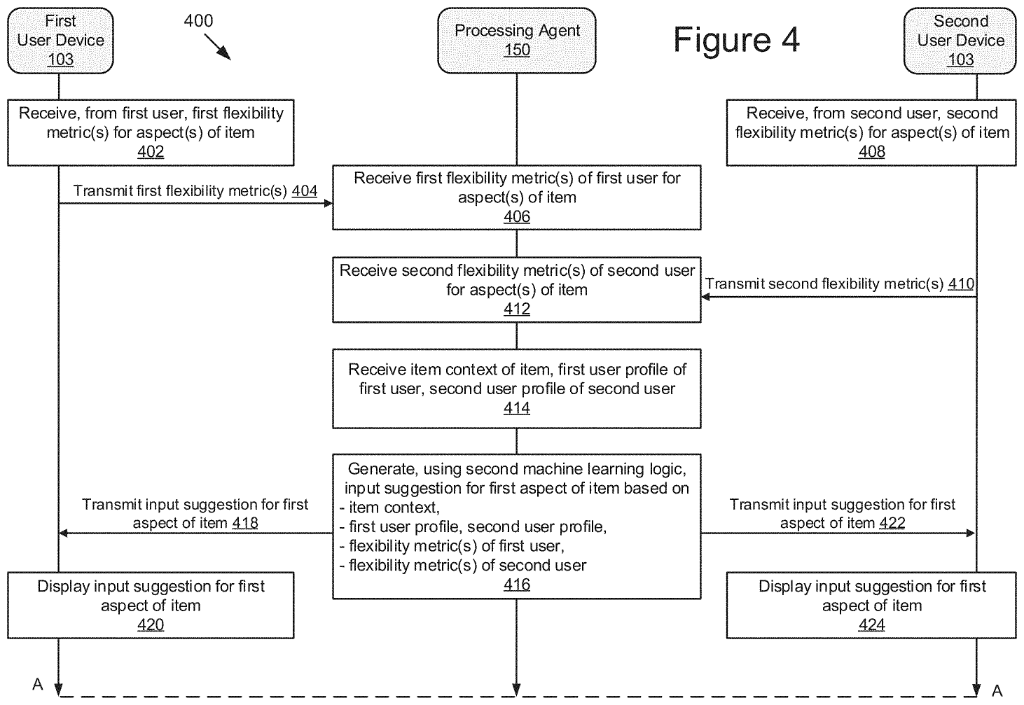

In some embodiments, to facilitate the first user 120 and the second user 120 in providing their user inputs for the first aspect of the item, the processing agent 150 may generate an input suggestion for the first aspect of the item and provide such input suggestion to the first user 120 and the second user 120. An example method 400 for generating the input suggestion for the first aspect of the item is illustrated in FIG. 4. In block 402, the first user device 103 may receive from the first user 120 one or more first flexibility metrics of the first user 120 for one or more aspects of the item. The first flexibility metric of the first user 120 corresponding to an aspect of the item may indicate the flexibility or the willingness of the first user 120 in adjusting his or her user input for the aspect of the item. In block 404, the first user device 103 may transmit the first flexibility metrics of the first user 120 for various aspects of the item to the processing agent 150. Similarly, in block 408, the second user device 103 may receive from the second user 120 one or more second flexibility metrics of the second user 120 for the one or more aspects of the item. The second flexibility metric of the second user 120 corresponding to an aspect of the item may indicate the flexibility or the willingness of the second user 120 in adjusting his or her user input for the aspect of the item. In block 410, the second user device 103 may transmit the second flexibility metrics of the second user 120 for various aspects of the item to the processing agent 150. In some embodiments, the first user 120 and the second user 120 may provide their flexibility metrics for various aspects of the item at any point in time during one or more user sessions associated with the item.

In block 406, the processing agent 150 may receive the first flexibility metric of the first user 120 for the aspects of the item from the first user device 103. In block 412, the processing agent 150 may receive the second flexibility metrics of the second user 120 for the aspects of the item from the second user device 103. Thus, the processing agent 150 may receive the first flexibility metric of the first user 120 and the second flexibility metrics of the second user 120 for various aspects of the same item.

In block 414, the processing agent 150 may receive the item context of the item, the first user profile of the first user 120, and the second user profile of the second user 120. In some embodiments, the input suggestion generator 204 may retrieve the item context of the item, the first user profile of the first user 120, and the second user profile of the second user 120 from the data store 152. In some embodiments, the item context of the item may describe the contextual scenario associated with the item that may affect the user inputs provided by the first user 120 and the second user 120 to negotiate the output object for the item. For example, the item may be a physical object (e.g., a house), and the item context of the item may describe one or more object features of the physical object (e.g., year built, home type, remodeled areas, included home appliances, etc.). In another example, the item may be an action between the first user 120 and the second user 120 (e.g., a litigation action), and the item context of the item may describe the situation context of the action (e.g., factual details, related testimonies and evidences, etc.). In some embodiments, the first user profile of the first user 120 may describe a value pattern of the user inputs that were provided, adjusted, and/or approved by the first user 120 for various aspects of different items, and thus the first user profile of the first user 120 may be used to estimate the user input that the first user 120 likely provides and/or accepts for the first aspect of the item. Similarly, the second user profile of the second user 120 may describe a value pattern of the user inputs that were provided, adjusted, and/or approved by the second user 120 for various aspects of different items, and thus the second user profile of the second user 120 may be used to estimate the user input that the second user 120 likely provides and/or accepts for the first aspect of the item.

In block 416, the processing agent 150 may generate an input suggestion for the first aspect of the item. In some embodiments, the input suggestion generator 204 may generate the input suggestion for the first aspect of the item based on the item context of the item, the first user profile of the first user 120, the second user profile of the second user 120, the first flexibility metrics of the first user 120, the second flexibility metric of the second user 120, etc., using a second machine learning logic. In some embodiments, the input suggestion generator 204 may apply the second machine learning logic to the item context of the item, the first user profile of the first user 120, the second user profile of the second user 120, the first flexibility metrics of the first user 120, the second flexibility metric of the second user 120, etc., to estimate one or more values that each of the first user 120 and the second user 120 may likely input and/or accept for the first aspect of the item given these factors. The input suggestion generator 204 may determine a value range for the first aspect of the item based on these estimated values and determine the input suggestion for the first aspect of the item to be this value range. In some embodiments, the input suggestion for the first aspect of the item may be the value range at which the estimated value(s) of the first user 120 and the estimated value(s) of the second user 120 for the first aspect of the item overlap. Alternatively, the input suggestion for the first aspect of the item may include both the estimated value(s) of the first user 120 and the estimated value(s) of the second user 120 for the first aspect of the item, and these estimated values may or may not overlap.

As an example, for the item that is a litigation action between the first user 120 and the second user 120, the input suggestion generator 204 may apply the second machine learning logic to the item context of the item, the user profile and the flexibility metrics of the first user 120 and the second user 120, and determine that the first user 120 likely provides the user input of [$200,000-$350,000] for the first aspect “compensatory damages” of the item, while the second user 120 likely provides the user input of [$300,000-$500,000] for the first aspect “compensatory damages” of the item. In this example, the input suggestion generator 204 may determine the value range at which these estimated user inputs overlap (e.g., [$300,000-$350,000]) to be the input suggestion for the first aspect “compensatory damages” of the item. Alternatively, the input suggestion generator 204 may determine the value range that includes both these estimated user inputs (e.g., [$200,000-$500,000]) to be the input suggestion for the first aspect “compensatory damages” of the item.

As another example, for the item that is a house in a property transaction between the first user 120 and the second user 120, the input suggestion generator 204 may apply the second machine learning logic to the item context of the item, the user profile and the flexibility metrics of the first user 120 and the second user 120, and determine that the first user 120 likely provides the user input of [$450,000-$600,000] for the first aspect “selling price” of the item, while the second user 120 likely provides the user input of [$350,000-$420,000] for the first aspect “selling price” of the item. In this example, because these estimated user inputs do not overlap, the input suggestion generator 204 may determine the value range that includes both these estimated user inputs (e.g., [$350,000-$600,000]) to be the input suggestion for the first aspect “selling price” of the item.

In some embodiments, once the input suggestion for the first aspect of the item is generated, in block 418, the input suggestion generator 204 may transmit the input suggestion for the first aspect of the item to the first user device 103. In block 420, the first user device 103 may display the input suggestion for the first aspect of the item to the first user 120 via the input/output components of the first user device 103. Similarly, in block 422, the input suggestion generator 204 may transmit the input suggestion for the first aspect of the item to the second user device 103. In block 424, the second user device 103 may display the input suggestion for the first aspect of the item to the second user 120 via the input/output components of the second user device 103. Thus, the first user 120 and the second user 120 may reference the input suggestion for the first aspect of the item when they provide their user inputs for the first aspect of the item, thereby increasing the likelihood that their user inputs may include one or more values satisfying both the first user 120 and the second user 120. In some embodiments, the method 400 in FIG. 4 may be followed by the method 300 in FIGS. 3A and 3B, in which the first user 120 and the second user 120 may provide their user inputs for the first aspect of the item and the output value for the first aspect of the item may be determined from these user inputs to generate the output object associated with the item.

Referring back to FIGS. 3A and 3B, if in block 314, the processing agent 150 determines that the first user input of the first user 120 for the first aspect of the item does not overlap with the second user input of the second user 120 for the first aspect of the item, the method 300 may proceed to block 316. In block 316, the processing agent 150 may generate an input disparity notification indicating that the first user input of the first user 120 and the second user input of the second user 120 for the first aspect of the item do not include any value in common. In block 318, the processing agent 150 may transmit the input disparity notification to the first user device 103 of the first user 120. In block 320, the processing agent 150 may transmit the input disparity notification to the second user device 103 of the second user 120. As an example, in scenario 760 in FIG. 7C, the input processing engine 202 may determine that the lower limit 772 of the first value range 762 provided by the first user 120 for the first aspect of the item is higher than the upper limit 774 of the second value range 764 provided by the second user 120 for the first aspect of the item, and thus there is no value lying within both the first value range 762 and the second value range 764 to be selected as the output value for the first aspect of the item. In this example, the notification engine 206 may generate an input disparity notification and transmit the input disparity notification to the first user device 103 and the second user device 103.

In block 319, the first user device 103 may display the input disparity notification associated with the first aspect of the item to the first user 120. In block 321, the second user device 103 may display the input disparity notification associated with the first aspect of the item to the second user 120. As the input disparity notification is displayed to the first user 120 and the second user 120, the method 300 may proceed to block 302 and/or block 308 in which the first user 120 may provide a different first user input and/or the second user 120 may provide a different second user input for the first aspect of the item in another attempt to determine an output value for the first aspect of the item that satisfies both the first user 120 and the second user 120. The output value for the first aspect of the item may be determined from the different first user input of the first user 120 and the different second user input of the second user 120 in a manner similar to determining the output value for the first aspect of the item from the first user input of the first user 120 and the second user input of the second user 120 as discussed above.

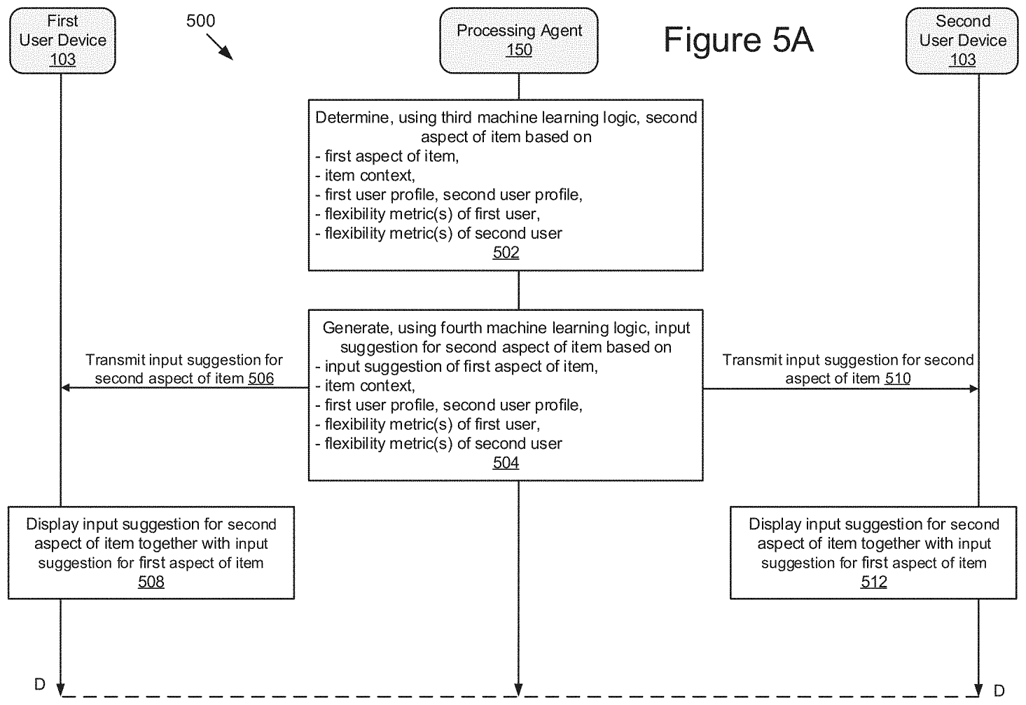

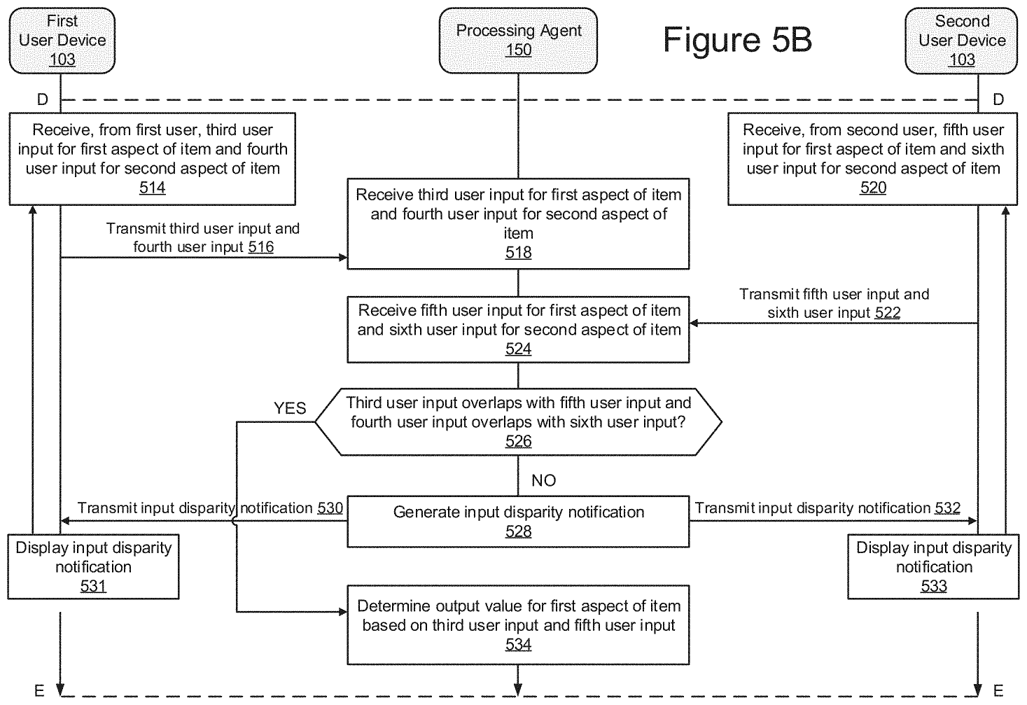

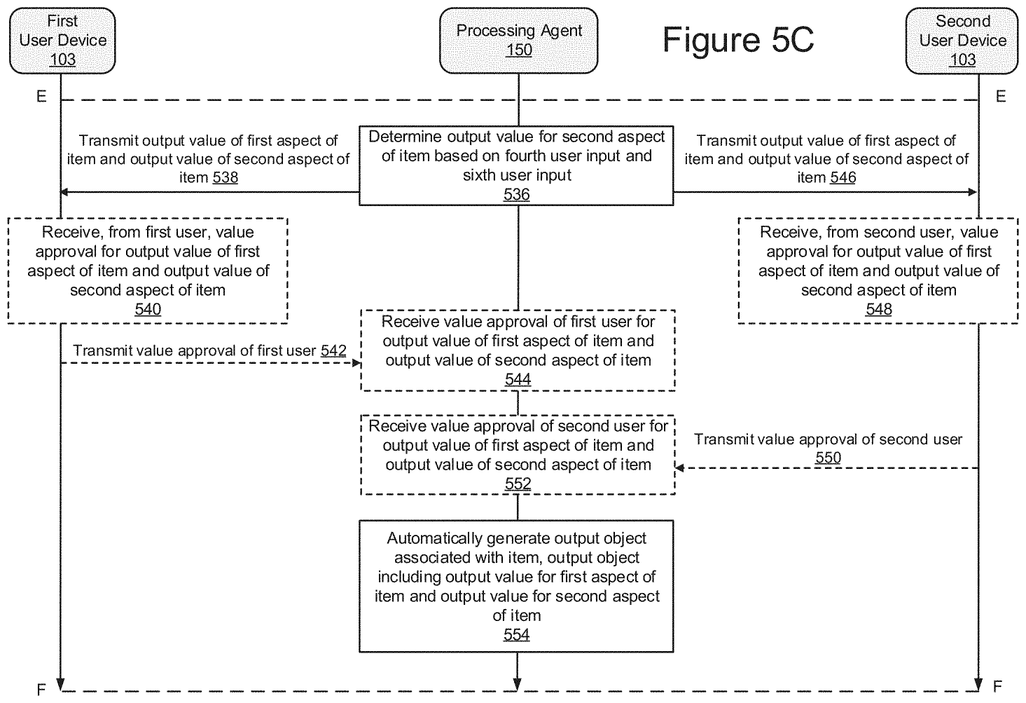

In some embodiments, if there is no output value for the first aspect of the item that satisfies the first user input of the first user 120 and the second user input of the second user 120 for the first aspect of the item, it is more likely that the user inputs provided in combination for the first aspect of the item and for other aspect(s) of the item by the first user 120 and the second user 120 may collectively satisfy both the first user 120 and the second user 120 due to the compensation of benefit between these aspects of the item. FIGS. 5A-5C illustrate a flowchart of an example method 500 for generating an output object for an item in which the user inputs for multiple aspects of the item are provided together by each related user. In some embodiments, the method 500 may be performed in response to the processing agent 150 determining that the first user input of the first user 120 for the first aspect of the item does not overlap with the second user input of the second user 120 for the first aspect of the item, and thus there is no output value for the first aspect of the item that satisfies both the first user 120 and the second user 120.

In block 502, the processing agent 150 may determine a second aspect of the item based on the first aspect of the item for which there is no output value that satisfies both the first user 120 and the second user 120. In some embodiments, the input suggestion generator 204 may determine the second aspect of the item based on the first aspect of the item using a third machine learning logic. The input suggestion generator 204 may apply the third machine learning logic to the first aspect of the item, the item context of the item, the first user profile of the first user 120, the second user profile of the second user 120, the first flexibility metrics of the first user 120, the second flexibility metric of the second user 120, etc., to determine the second aspect of the item that the first user 120 and the second user 120 may likely consider in combination with the first aspect of the item.

Continuing the example related to the item that is the litigation action between the first user 120 and the second user 120, for the first aspect “compensatory damages” of the item, the input suggestion generator 204 may apply the third machine learning logic to the first aspect “compensatory damages” of the item, the item context of the item, the user profiles and the flexibility metrics of the first user 120 and the second user 120, and determine that the first user 120 and the second user 120 may likely consider the first aspect “compensatory damages” of the item together with the second aspect “sentencing time” of the item. Thus, the user input provided by the first user 120 for the first aspect “compensatory damages” of the item may likely be impacted by the user input provided by the first user 120 for the second aspect “sentencing time” of the item and vice versa. Similarly, the user input provided by the second user 120 for the first aspect “compensatory damages” of the item may likely be impacted by the user input provided by the second user 120 for the second aspect “sentencing time” of the item and vice versa. Therefore, if there is no output value satisfying both the first user 120 and the second user 120 for the first aspect “compensatory damages” of the item, it is likely that there is a pair of output values for the first aspect “compensatory damages” and the second aspect “sentencing time” of the item that collectively satisfy both the first user 120 and the second user 120.

Continuing the example related to the item that is the house in the property transaction between the first user 120 and the second user 120, for the first aspect “selling price” of the item, the input suggestion generator 204 may apply the third machine learning logic to the first aspect “selling price” of the item, the item context of the item, the user profiles and the flexibility metrics of the first user 120 and the second user 120, and determine that the first user 120 and the second user 120 may likely consider the first aspect “selling price” of the item together with the second aspect “remodeled areas” of the item. The user input provided by the first user 120 for the first aspect “selling price” of the item may likely be impacted by the user input provided by the first user 120 for the second aspect “remodeled areas” of the item and vice versa. Similarly, the user input provided by the second user 120 for the first aspect “selling price” of the item may likely be impacted by the user input provided by the second user 120 for the second aspect “remodeled areas” of the item and vice versa. Therefore, if there is no output value satisfying both the first user 120 and the second user 120 for the first aspect “selling price” of the item, it is likely that there is a pair of output values for the first aspect “selling price” and the second aspect “remodeled areas” of the item that collectively satisfy both the first user 120 and the second user 120.

In block 504, the processing agent 150 may generate an input suggestion for the second aspect of the item based on the input suggestion for the first aspect of the item. In some embodiments, the input suggestion generator 204 may determine the input suggestion for the second aspect of the item based on the input suggestion for the first aspect of the item using a fourth machine learning logic. The input suggestion generator 204 may apply the fourth machine learning logic to the input suggestion for the first aspect of the item, the item context of the item, the first user profile of the first user 120, the second user profile of the second user 120, the first flexibility metrics of the first user 120, the second flexibility metric of the second user 120, etc., to determine one or more values that each of the first user 120 and the second user 120 may likely input and/or accept for the second aspect of the item given the input suggestion for the first aspect of the item and the other factors. The input suggestion generator 204 may determine a value range for the second aspect of the item based on these estimated values and determine the input suggestion for the second aspect of the item to be this value range. In some embodiments, the input suggestion for the second aspect of the item may be the value range at which the estimated value(s) of the first user 120 and the estimated value(s) of the second user 120 for the second aspect of the item overlap. Alternatively, the input suggestion for the second aspect of the item may include both the estimated value(s) of the first user 120 and the estimated value(s) of the second user 120 for the second aspect of the item, and these estimated values may or may not overlap.

Continuing the example related to the item that is the litigation action between the first user 120 and the second user 120, the input suggestion generator 204 may apply the fourth machine learning logic to the input suggestion for the first aspect “compensatory damages” of the item (e.g., [$300,000-$350,000]), the item context of the item, the user profile and the flexibility metrics of the first user 120 and the second user 120, and determine that given the input suggestion of [$300,000-$350,000] for the first aspect “compensatory damages” of the item, the first user 120 likely provides the user input of [1.5 years-3 years] for the second aspect “sentencing time” of the item, and the second user 120 likely provides the user input of [2.5 years-5 years] for the second aspect “sentencing time” of the item. In this example, the input suggestion generator 204 may determine the value range at which these estimated user inputs overlap (e.g., [2.5 years-3 years]) to be the input suggestion for the second aspect “sentencing time” of the item. Alternatively, the input suggestion generator 204 may determine the value range that includes both these estimated user inputs (e.g., [1.5 years-5 years]) to be the input suggestion for the second aspect “sentencing time” of the item. Thus, as the user input for the first aspect “compensatory damages” of the item may impact the user input for the second aspect “sentencing time” of the item and vice versa, the input suggestion for the second aspect “sentencing time” of the item may depend on the input suggestion for the first aspect “compensatory damages” of the item.

Continuing the example related to the item that is the house in the property transaction between the first user 120 and the second user 120, the input suggestion generator 204 may apply the fourth machine learning logic to the input suggestion for the first aspect “selling price” of the item (e.g., [$350,000-$600,000]), the item context of the item, the user profile and the flexibility metrics of the first user 120 and the second user 120, and determine that given the input suggestion of [$350,000-$600,000] for the first aspect “selling price” of the item, the first user 120 likely provides the user input of (carpet, wall painting) for the second aspect “remodeled areas” of the item, and the second user 120 likely provides the user input of (carpet, roof, kitchen) for the second aspect “remodeled areas” of the item. In this example, the input suggestion generator 204 may determine the value range at which these estimated user inputs overlap (e.g., carpet) to be the input suggestion for the second aspect “remodeled areas” of the item. Alternatively, the input suggestion generator 204 may determine the value range that includes both these estimated user inputs (e.g., carpet, wall painting, roof, kitchen) to be the input suggestion for the second aspect “remodeled areas” of the item. Thus, as the user input for the first aspect “selling price” of the item may impact the user input for the second aspect “remodeled areas” of the item and vice versa, the input suggestion for the second aspect “remodeled areas” of the item may depend on the input suggestion for the first aspect “selling price” of the item.

In some embodiments, once the input suggestion for the second aspect of the item is generated, in block 506, the input suggestion generator 204 may transmit the input suggestion for the second aspect of the item to the first user device 103. In block 508, the first user device 103 may display the input suggestion for the second aspect of the item together with the input suggestion for the first aspect of the item to the first user 120 via the input/output components of the first user device 103. Similarly, in block 510, the input suggestion generator 204 may transmit the input suggestion for the second aspect of the item to the second user device 103. In block 512, the second user device 103 may display the input suggestion for the second aspect of the item together with the input suggestion for the first aspect of the item to the second user 120 via the input/output components of the second user device 103. Thus, the first user 120 and the second user 120 may reference the input suggestion for the first aspect of the item and the input suggestion for the second aspect of the item when they provide their user inputs for the first aspect of the item together with their user inputs for the second aspect of the item.

Continuing the example related to the item that is the litigation action between the first user 120 and the second user 120, the first user device 103 may simultaneously display the input suggestion of [$300,000-$350,000] for the first aspect “compensatory damages” of the item and the input suggestion of [1.5 years-5 years] for the second aspect “sentencing time” of the item to the first user 120. Similarly, the second user device 103 may simultaneously display the input suggestion of [$300,000-$350,000] for the first aspect “compensatory damages” of the item and the input suggestion of [1.5 years-5 years] for the second aspect “sentencing time” of the item to the second user 120. Continuing the example related to the item that is the house in the property transaction between the first user 120 and the second user 120, the first user device 103 may simultaneously display the input suggestion of [$350,000-$600,000] for the first aspect “selling price” of the item and the input suggestion of (carpet, wall painting, roof, kitchen) for the second aspect “remodeled areas” of the item to the first user 120. Similarly, the second user device 103 may simultaneously display the input suggestion of [$350,000-$600,000] for the first aspect “selling price” of the item and the input suggestion of (carpet, wall painting, roof, kitchen) for the second aspect “remodeled areas” of the item to the second user 120.

In some embodiments, each of the first user 120 and the second user 120 may reference the input suggestion for the first aspect of the item and the input suggestion for the second aspect of the item, and provide the user input for the first aspect of the item together with the user input for the second aspect of the item as a pair of user inputs for the item. Each user may provide the user input for the second aspect of the item with a consideration of the user input that the user provides for the first aspect of the item and vice versa to balance the overall benefit between the first aspect of the item and the second aspect of the item as the user desires.

In block 514, the first user device 103 may receive from the first user 120 a third user input for the first aspect of the item and a fourth user input for the second aspect of the item. The third user input provided by the first user 120 for the first aspect of the item may be different from the first user input that the first user 120 previously provided for the first aspect of the item but did not result in an output value for the first aspect of the item that satisfies both the first user 120 and the second user 120. In block 516, the first user device 103 may transmit the third user input of the first user 120 for the first aspect of the item and the fourth user input of the first user 120 for the second aspect of the item to the processing agent 150. Similarly, in block 520, the second user device 103 may receive from the second user 120 a fifth user input for the first aspect of the item and a sixth user input for the second aspect of the item. The fifth user input provided by the second user 120 for the first aspect of the item may be different from the second user input that the second user 120 previously provided for the first aspect of the item but did not result in an output value for the first aspect of the item that satisfies both the first user 120 and the second user 120. In block 522, the second user device 103 may transmit the fifth user input of the second user 120 for the first aspect of the item and the sixth user input of the second user 120 for the second aspect of the item to the processing agent 150.

In block 518, the processing agent 150 may receive the third user input of the first user 120 for the first aspect of the item and the fourth user input of the first user 120 for the second aspect of the item from the first user device 103. In block 524, the processing agent 150 may receive the fifth user input of the second user 120 for the first aspect of the item and the sixth user input of the second user 120 for the second aspect of the item from the second user device 103. Thus, the processing agent 150 may receive a pair of the third user input and the fourth user input provided by the first user 120 and a pair of the fifth user input and the sixth user input provided by the second user 120 for the first aspect and the second aspect of the same item.

In block 526, the processing agent 150 may determine whether the third user input of the first user 120 for the first aspect of the item overlaps with the fifth user input of the second user 120 for the first aspect of the item, and whether the fourth user input of the first user 120 for the second aspect of the item overlaps with the sixth user input of the second user 120 for the second aspect of the item. In some embodiments, the input processing engine 202 of the processing agent 150 may determine whether the third user input of the first user 120 and the fifth user input of the second user 120 for the first aspect of the item overlap with one another, and whether the fourth user input of the first user 120 and the sixth user input of the second user 120 for the second aspect of the item overlap with one another in the same manner that the input processing engine 202 determines whether the first user input of the first user 120 and the second user input of the second user 120 for the first aspect of the item overlap with one another in block 314 of the method 300 in FIGS. 3A and 3B. For example, for the first aspect of the item, the input processing engine 202 may determine whether the third user input of the first user 120 matches the fifth user input of the second user 120 or includes at least a portion of the fifth user input of the second user 120. For the second aspect of the item, the input processing engine 202 may determine whether the fourth user input of the first user 120 matches the sixth user input of the second user 120 or includes at least a portion of the sixth user input of the second user 120.

If in block 526, the processing agent 150 determines that the third user input of the first user 120 for the first aspect of the item does not overlap with the fifth user input of the second user 120 for the first aspect of the item and/or determines that the fourth user input of the first user 120 for the second aspect of the item does not overlap with the sixth user input of the second user 120 for the second aspect of the item, the method 500 may proceed to block 528. In block 528, the processing agent 150 may generate an input disparity notification indicating that the user input of the first user 120 and the user input of the second user 120 for at least one of the first aspect and the second aspect of the item do not include any value in common. In block 530, the processing agent 150 may transmit the input disparity notification to the first user device 103 of the first user 120. In block 532, the processing agent 150 may transmit the input disparity notification to the second user device 103 of the second user 120.

In block 531, the first user device 103 may display the input disparity notification associated with the first aspect and the second aspect of the item to the first user 120. In block 533, the second user device 103 may display the input disparity notification associated with the first aspect and the second aspect of the item to the second user 120. As the input disparity notification is displayed to the first user 120 and the second user 120, the method 500 may proceed to block 514 and/or block 520 in which the first user 120 may provide a different pair of third user input and fourth user input, and/or the second user 120 may provide a different pair of fifth user input and sixth user input for the first aspect and the second aspect of the item in another attempt to determine the output values for the first aspect and the second aspect of the item that satisfy both the first user 120 and the second user 120.

If in block 526, the processing agent 150 determines that the third user input of the first user 120 for the first aspect of the item overlaps with the fifth user input of the second user 120 for the first aspect of the item, and that the fourth user input of the first user 120 for the second aspect of the item overlaps with the sixth user input of the second user 120 for the second aspect of the item, the method 500 may proceed to block 534. In block 534, the processing agent 150 may determine an output value for the first aspect of the item based on the third user input of the first user 120 and the fifth user input of the second user 120 for the first aspect of the item. In block 536, the processing agent 150 may determine an output value for the second aspect of the item based on the fourth user input of the first user 120 and the sixth user input of the second user 120 for the second aspect of the item. In some embodiments, the input processing engine 202 of the processing agent 150 may determine the output value for the first aspect of the item based on the third user input of the first user 120 and the fifth user input of the second user 120, and determine the output value for the second aspect of the item based on the fourth user input of the first user 120 and the sixth user input of the second user 120 in the same manner that the input processing engine 202 determines the output value for the first aspect of the item based on the first user input of the first user 120 and the second user input of the second user 120 in block 322 of the method 300 in FIGS. 3A and 3B. For example, if the third user input of the first user 120 for the first aspect of the item matches the fifth user input of the second user 120 for the first aspect of the item, the input processing engine 202 may determine the output value for the first aspect of the item to be the third user input of the first user 120 matching the fifth user input of the second user 120. In another example, the input processing engine 202 may apply the first machine learning logic to the third user input of the first user 120 and the fifth user input of the second user 120 to determine the output value for the first aspect of the item.

In some embodiments, once the output value of the first aspect of the item and the output value of the second aspect of the item are determined, in block 538, the input processing engine 202 of the processing agent 150 may transmit the output value of the first aspect of the item and the output value of the second aspect of the item to the first user device 103. The first user device 103 may display the output value of the first aspect of the item and the output value of the second aspect of the item to the first user 120 via the input/output components of the first user device 103. In block 540, the first user device 103 may receive from the first user 120 a value approval for the output value of the first aspect of the item and the output value of the second aspect of the item via the input/output components of the first user device 103. In block 542, the first user device 103 may transmit the value approval of the first user 120 for the output value of the first aspect of the item and the output value of the second aspect of the item to the processing agent 150. Similarly, in block 546, the input processing engine 202 may transmit the output value of the first aspect of the item and the output value of the second aspect of the item to the second user device 103. The second user device 103 may display the output value of the first aspect of the item and the output value of the second aspect of the item to the second user 120 via the input/output components of the second user device 103. In block 548, the second user device 103 may receive from the second user 120 a value approval for the output value of the first aspect of the item and the output value of the second aspect of the item via the input/output components of the second user device 103. In block 550, the second user device 103 may transmit the value approval of the second user 120 for the output value of the first aspect of the item and the output value of the second aspect of the item to the processing agent 150.

In block 544, the processing agent 150 may receive the value approval of the first user 120 for the output value of the first aspect of the item and the output value of the second aspect of the item from the first user device 103. In block 552, the processing agent 150 may receive the value approval of the second user 120 for the output value of the first aspect of the item and the output value of the second aspect of the item from the second user device 103. Thus, the processing agent 150 may receive the value approval of the first user 120 and the value approval of the second user 120 for the output value of the first aspect of the item and the output value of the second aspect of the item.

In block 554, the processing agent 150 may automatically generate the output object associated with the item, the output object may include the output value of the first aspect of the item and the output value of the second aspect of the item. In some embodiments, to generate the output object, the output object generator 208 of the processing agent 150 may retrieve an object template of the output object associated with the item from the data store 152, and populate the object template of the output object with the output value of the first aspect of the item and the output value of the second aspect of the item. Alternatively, if the output object associated with the item was previously created, the output object generator 208 may retrieve the output object associated with the item, and update the output object associated with the item to include the output value of the first aspect of the item and the output value of the second aspect of the item. Thus, by determining the second aspect of the item based on the first aspect of the item and providing an option for each of the first user 120 and the second user 120 to provide their user inputs for the first aspect of the item and the second aspect of the item in combination, the processing agent 150 may determine a pair of output values for the first aspect of the item and the second aspect of the item that together satisfy the first user 120 and the second user 120. This implementation is advantageous, because the first aspect of the item and the second aspect of the item when being considered individually may not result in an output value for such aspect that satisfies the first user 120 and the second user 120.

In some embodiments, the operations in blocks 540, 542, 544, 548, 550, 552 of the method 500 may be optional. For example, in some embodiments, the first user device 103 and the second user device 103 may not receive the value approval of the first user 120 and/or the second user 120 for the output value of the first aspect of the item and the output value of the second aspect of the item, and therefore the processing agent 150 may not receive these value approvals from the first user device 103 of the first user 120 and/or the second user device 103 of the second user 120. Thus, the processing agent 150 may automatically generate the output object including the output value of the first aspect of the item and the output value of the second aspect of the item without the explicit approvals of the first user 120 and the second user 120 for the output value of the first aspect of the item and the output value of the second aspect of the item. In these embodiments, once the first user 120 and the second user 120 provide their pair of user inputs for the first aspect of the item and the second aspect of the item, if their user inputs for the first aspect of the item overlap and their user inputs for the second aspect of the item overlap, the output value for the first aspect of the item and the output value for the second aspect of the item can be computed from the corresponding user inputs of the first user 120 and the second user 120 as discussed above. These output values may be considered as automatically accepted by the first user 120 and the second user 120 and may be automatically included in the output object that the first user 120 and the second user 120 are required to comply with.

As discussed elsewhere herein, the processing agent 150 may implement various machine learning logics to perform various operations for generating the output object associated with the item. In some embodiments, the first machine learning logic that computes the output value for the first aspect of the item, the second machine learning logic that generates the input suggestion for the first aspect of the item, the third machine learning logic that determines the second aspect of the item based on the first aspect of the item, and the fourth machine learning logic that generates the input suggestion for the second aspect of the item based on the input suggestion for the first aspect of the item may be distinct from one another and may operate using different set of input factors that partially overlap. As discussed elsewhere herein, the first machine learning logic may compute the output value for the first aspect of the item based on the item context of the item, the threshold value of the first user input provided by the first user 120 for the first aspect of the item, the threshold value of the second user input provided by the second user 120 for the first aspect of the item, etc. The second machine learning logic may generate the input suggestion for the first aspect of the item based on the item context of the item, the user profiles of the first user 120 and the second user 120, the flexibility metrics of the first user 120 and the second user 120, etc. The third machine learning logic may determine second aspect of the item based on the first aspect of the item, the item context of the item, the user profiles of the first user 120 and the second user 120, the flexibility metrics of the first user 120 and the second user 120, etc. The fourth machine learning logic may generate the input suggestion for the second aspect of the item based on the input suggestion for the first aspect of the item that is generated by the second machine learning logic, the item context of the item, the user profiles of the first user 120 and the second user 120, the flexibility metrics of the first user 120 and the second user 120, etc.

In some embodiments, these machine learning logics may be trained using multiple datasets associated with multiple user sessions in which various users may provide their user inputs for various items to negotiate the output objects for these items. Thus, from these multiple datasets, each machine learning logic may learn to perform their operations based on their corresponding input factors. For example, the first machine learning logic may learn to compute a fair and reasonable output value for a particular aspect of an item that likely satisfies the related users given the item context of the item, the user inputs provided by the related users for the particular aspect of the item, and/or other factors. In another example, the second machine learning logic may learn to determine for the particular aspect of the item a value range that includes one or more values potentially satisfying the related users given the item context of the item, the user profiles and the flexibility metrics of the related users, historical data and/or other factors. As discussed elsewhere herein, such value range may be provided to the related users as the input suggestion for the particular aspect of the item.

In another example, the third machine learning logic may learn to determine for the particular aspect of the item a different aspect of the item that the related users may likely consider in combination with the particular aspect of the item given the particular aspect of the item, the item context of the item, the user profiles and the flexibility metrics of the related users, and/or other factors. As discussed elsewhere herein, the likelihood that there is a pair of output values for these two aspects of the item collectively satisfying the related users may be higher than the likelihood that there is an output value for the particular aspect of the item satisfying the related users, because of the compensation of benefits between these two aspects of the item. In another example, the fourth machine learning logic may learn to determine a value range for the different aspect of the item given the value range determined for the particular aspect of the item by the second machine learning logic, the item context of the item, the user profile of the first user 120 and the second user 120, the flexibility metrics of the first user 120 and the second user 120, etc. As discussed elsewhere herein, the values in the value range determined for the particular aspect of the item by the second machine learning logic may couple with the values in the value range determined for the different aspect of the item by the fourth machine learning logic to form one or more pairs of values for the particular aspect and the different aspect of the item that potentially satisfy the related users. These value ranges may be provided in combination to the related users as the input suggestions for the particular aspect and the different aspect of the item.

As discussed elsewhere herein, the processing agent 150 may be implemented in the server 110 that is distinct from the first user device 103 of the first user 120 and the second user device 103 of the second user 120. Therefore, while the processing agent 150 may receive the user input of the first user 120 from the first user device 103 of the first user 120 and receive the user input of the second user 120 from the second user device 103 of the second user 120 for the same aspect of the item, the first user 120 may not be aware of the user input provided by the second user 120 for the aspect of the item, and the second user 120 may not be aware of the user input provided by the first user 120 for the aspect of the item. As a result, the first user 120 may not subjectively adjust his or her own user input for the aspect of the item based on the user input provided by the second user 120 for the aspect of the item and vice versa.

As an example, the processing agent 150 may generate an output object for an item that is a patent litigation action between the first user 120 and the second user 120. The processing agent 150 may receive a first value range of the first user 120 for a first aspect “settlement amount” of the item from the first user device 103 of the first user 120 (e.g., [$150,000-$500,000]), and receive a second value range of the second user 120 for the first aspect “settlement amount” of the item from the second user device 103 of the second user 120 (e.g., [$300,000-$700,000]). The processing agent 150 may determine that the first value range of the first user 120 and the second value range of the second user 120 for the first aspect “settlement amount” of the item overlap, and determine an overlap range between a threshold value of the first value range provided by the first user 120 and a threshold value of the second value range provided by the second user 120. In this example, the processing agent 150 may determine the overlap range to be [$300,000-$500,000] that is located between the lower limit of the second value range of the second user 120 (e.g., $300,000) and the upper limit of the first value range of the first user 120 (e.g., $500,000).

The processing agent 150 may determine an output value in the overlap range for the first aspect “settlement amount” of the item based on the threshold value of the first value range and the threshold value of the second value range that are associated with the overlap range. The output value in the overlap range may satisfy a predefined ratio relative to the threshold value of the first value range and the threshold value of the second value range that are associated with the overlap range. In this example, the output value for the first aspect “settlement amount” of the item may divide the overlap range in half with the predefined ratio of (50%:50%). Thus, the output value for the first aspect “settlement amount” of the item may be $400,000 that is located at the midpoint of the overlap range [$300,000-$500,000] and satisfy both the first value range [$150,000-$500,000] provided by the first user 120 and the second value range [$300,000-$700,000] provided by the second user 120 for the first aspect “settlement amount” of the item. The processing agent 150 may then transmit the output value of the first aspect “settlement amount” of the item (e.g., $400,000) to the first user device 103 of the first user 120 and the second user device 103 of the second user 120.

In some embodiments, to determine the output value of the first aspect “settlement amount” of the item, the processing agent 150 may compare the overlap range to a difference threshold. For example, the processing agent 150 may compute a difference between the threshold value of the first value range provided by the first user 120 and the threshold value of the second value range provided by the second user 120 that are associated with the overlap range (e.g., $200,000), and determine whether such a difference satisfies the difference threshold (e.g., less than $450,000). If the difference between the threshold values associated with the overlap range does not satisfy the difference threshold, the processing agent 150 may determine that the overlap range does not satisfy the difference threshold, and thus determine that the first value range provided by the first user 120 and the second value range provided by the second user 120 for the first aspect “settlement amount” of the item are relatively different from one another. In this situation, the processing agent 150 may compute the output value in the overlap range for the first aspect “settlement amount” of the item using a machine learning logic. For example, the processing agent 150 may apply the first machine learning logic discussed elsewhere herein to the threshold value of the first value range provided by the first user 120, the threshold value of the second value range provided by the second user 120, the item context of the item (e.g., remaining patent term of the patent, number of times the patent right of the patent is successfully asserted, size of related patent portfolio, etc.), etc., to determine the output value for the first aspect “settlement amount” of the item in the overlap range.

In some embodiments, the processing agent 150 may also facilitate the first user 120 and the second user 120 in providing their input value ranges for the first aspect “settlement amount” of the item. As discussed elsewhere herein, the processing agent 150 may receive the item context of the item, the first user profile of the first user 120, and the second user profile of the second user 120 from the data store 152. The processing agent 150 may also receive the one or more flexibility metrics of the first user 120 for various aspects of the item from the first user device 103 of the first user 120, and receive one or more flexibility metrics of the second user 120 for various aspects of the item from the second user device 103 of the second user 120. These flexibility metrics may indicate the flexibility or the willingness of the first user 120 and the second user 120 in adjusting his or her user input for these aspects of the item. In some embodiments, the processing agent 150 may generate a value range suggestion for the first aspect “settlement amount” of the item based on these factors using a machine learning logic. For example, the processing agent 150 may apply the second machine learning logic discussed elsewhere herein to the item context of the item, the first user profile of the first user 120, the second user profile of the second user 120, the one or more flexibility metrics of the first user 120, the one or more flexibility metrics of the second user 120, etc., to determine the value range suggestion for the first aspect “settlement amount” of the item. In this example, the processing agent 150 may generate the value range suggestion of [$200,000-$600,000] for the first aspect “settlement amount” of the item.

In some embodiments, the processing agent 150 may transmit the value range suggestion for the first aspect “settlement amount” of the item (e.g., [$200,000-$600,000]) to the first user device 103 of the first user 120 and the second user device 103 of the second user 120. The first user device 103 of the first user 120 and the second user device 103 of the second user 120 may display the value range suggestion for the first aspect “settlement amount” of the item to the first user 120 and the second user 120. The first user 120 and the second user 120 may reference this value range suggestion and provide their user inputs for the first aspect “settlement amount” of the item accordingly. In this example, the first user 120 may reference the value range suggestion of [$200,000-$600,000] and input the first value range of [$150,000-$500,000] for the first aspect “settlement amount” of the item. The second user 120 may reference the value range suggestion of [$200,000-$600,000] and input the second value range [$300,000-$700,000] for the first aspect “settlement amount” of the item. Providing the value range suggestion for the first aspect “settlement amount” of the item to the first user 120 and the second user 120 is advantageous, because it increases the likelihood that the value ranges input by the first user 120 and the second user 120 for the first aspect “settlement amount” of the item include one or more values satisfying both the first user 120 and the second user 120.

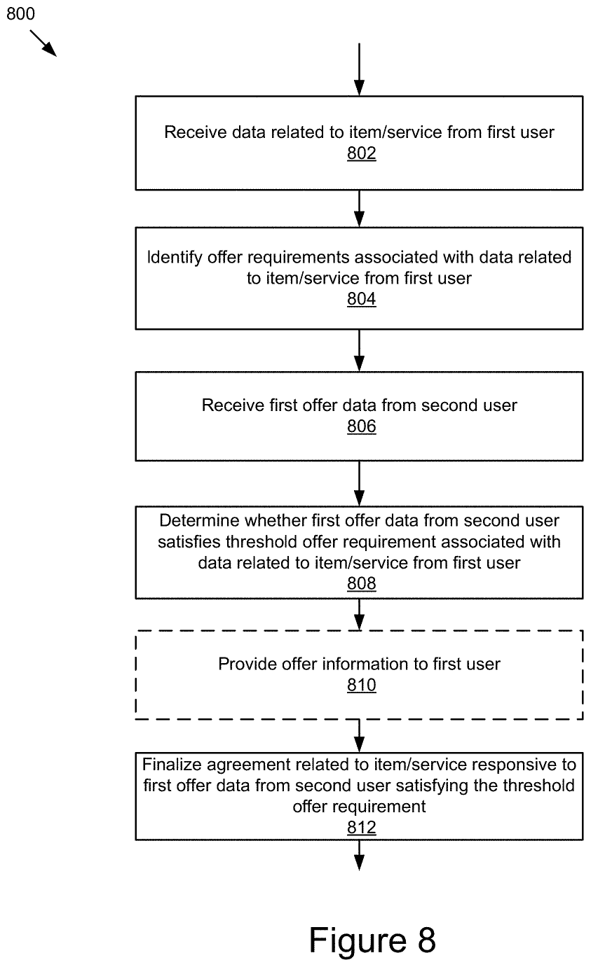

FIG. 8 is a flowchart 800 of an example method for facilitating an offer for one or more of goods or services. At 802, the processing agent 150 receives data related to an item or service from a first user 120a. In some implementations, the first user 120a may create a post, advertisement, or listing on an electronic marketplace or social network. In some implementations, the processing agent 150 may be incorporated into the electronic marketplace or social network, while in further implementations, the electronic marketplace or social network may instead collect data related to the item or service and provide that data to the processing agent 150, such as in a third-party affiliate option, etc.

In some implementations, the data related to the item or service may include data that can be used to characterize the item or service, such as images, character strings that include details about the item or service, object data, location data, and/or other metadata that will provide details about the good or service to potential buyers that view the data. For example, if the good is a vehicle that is being offered for sale, the data may include one or more of an image of the vehicle, a make of the vehicle, a model of the vehicle, a year of the vehicle, a color of the vehicle, a milage of the vehicle, an ownership history of the vehicle, etc. In another example, if the service is an offer to perform yard maintenance, the data may include one or more of an image, such as of previous jobs, information about the type of yard maintenance that is performed, the timeline of engagement or completion of a yard maintenance job, a quantity of workers for a yard maintenance job, a listing of additional equipment that can be included, such as a drop-down selection menu that can be populated with selectable options by the first user, such as a lawn mower, a skid steer, a pressure washer, a dumpster, etc. In some implementations, the data may include a high-level description that takes up less memory space and can include one or more hyperlinks to more detailed descriptions about the item or service that are provided separately from the original data received by the processing agent 150.

At 804, the processing agent 150 may identify offer requirements associated with the data related to the goods or service from the first user. For example, the offer requirements may include details about a quantity or amount that the first user would accept for a good or service. In some implementations, the quantity or amount that the first user would accept for a good or service may include a minimum threshold value, while in further implementations, the quantity or amount that the first user would accept for a good or service may include a minimum and/or maximum threshold, e.g., a window of offers that would be accepted. In some implementations, the offer requirements may include additional details related to conditions that the user would accept for the good or service. For example, those offer requirements may include a timeline or timeline window in which a good or service is to be delivered or completed. For example, an offer for yard maintenance may include both how much they would accept for a job and how long that job would last, e.g., basic yard maintenance to mow a lawn would accept offers between $100-$200 to mow the lawn for up to three hours with a crew of four workers, upon which the service would be deemed complete. In additional implementations, the services may also include other parameters for the service, such as a size or dimension of the project, duration of the project, possible options of non-completion occurs after engagement of the service, etc. In some implementations, the goods may also include a return time, such as a rental or loan situation where the return date of the goods and condition of return is also required. The processing agent 150 may allow the data related to the offer requirements is kept private from all users other than the first user and other users are only able to submit “blind” offers for the good or service without knowing the offer details.

At 806, the processing agent 150 may receive a first offer from a second user 120b. The second user 120b may be able to view the data related to the item/service from the first user and based on that information submit an offer with one or more criteria to the processing agent 150. The first offer may include a string of character information including data about a price point for an offer of the goods or services. In some implementations, additional criteria for the offer may include offer for trade of other goods/services, rather than or with a monetary criteria included in an offer.

At 808, the processing agent 150 may determine whether the first offer from the second user 120b satisfies a threshold offer requirement associated with the data related to the goods or services from the first user. As discussed elsewhere herein, the processing agent 150 may compare the offer requirements associated with the data related to the goods or service from the first user to the first offer received from the second user 120b, such as the monetary offer and/or the one or more criteria. As described elsewhere herein, such as with respect to FIG. 7, if the first offer matches with one or more portions of the offer requirements, than the processing agent 150 may determine that an offer has been made with acceptance. At 810, in some implementations, the offer information from the second user 120b may be provided to the first user 120a, such as where portions of the offer information satisfy the offer requirements, while in other implementations, if additional back and forth are required to finalize the offer.

At 812, the processing agent 150 may finalize an agreement between the first user 120a and the second user 120b responsive to the first offer data from the second user 120b satisfying the threshold offer requirements. In some implementations, the finalized agreement may be considered legally binding between the parties based on contractual agreements the parties agreed to prior to engaging in the use of the processing agent 150. Once the agreement is finalized, the processing agent 150 may provide any details related to the agreement to one or more of the parties.

It should be understood that the above-described example activities are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A method comprising:
receiving, from a first user device associated with a first user, a first user input for a first aspect of an item;
receiving, from a second user device associated with a second user, a second user input for the first aspect of the item;
determining whether the first user input of the first user for the first aspect of the item overlaps with the second user input of the second user for the first aspect of the item;
responsive to determining that the first user input of the first user for the first aspect of the item overlaps with the second user input of the second user for the first aspect of the item, determining an output value for the first aspect of the item based on the first user input of the first user and the second user input of the second user; and
automatically generating an output object associated with the item, the output object including the output value of the first aspect of the item.

2. The method of claim 1, wherein automatically generating the output object associated with the item includes:
retrieving an object template of the output object associated with the item; and
populating the object template of the output object with the output value of the first aspect of the item.

3. The method of claim 1, wherein determining that the first user input of the first user overlaps with the second user input of the second user includes one or more of:
determining that the first user input of the first user matches the second user input of the second user, the first user input and the second user input being selected from a plurality of predefined inputs associated with the first aspect of the item; and
determining that the first user input of the first user includes at least a portion of the second user input of the second user, the first user input and the second user input being a value range selected for the first aspect of the item.

4. The method of claim 1, wherein determining the output value for the first aspect of the item includes:
determining a threshold value of the first user input for the first aspect of the item;
determining a threshold value of the second user input for the first aspect of the item;
computing a difference value between the threshold value of the first user input and the threshold value of the second user input;
determining that the difference value between the threshold value of the first user input and the threshold value of the second user input satisfies a difference threshold; and
computing the output value for the first aspect of the item based on the difference value and one or more of the threshold value of the first user input and the threshold value of the second user input.

5. The method of claim 1, wherein determining the output value for the first aspect of the item includes:
determining a threshold value of the first user input for the first aspect of the item;
determining a threshold value of the second user input for the first aspect of the item;
computing a difference value between the threshold value of the first user input and the threshold value of the second user input;
determining that the difference value between the threshold value of the first user input and the threshold value of the second user input does not satisfy a difference threshold; and
computing, using a machine learning logic, the output value for the first aspect of the item based on an item context of the item, the threshold value of the first user input, and the threshold value of the second user input.

6. The method of claim 1, wherein the item is one of:
a physical object, wherein an item context of the item describes one or more object features of the physical object; and
an action between the first user and the second user, wherein the item context of the item describes a situation context of the action.

7. The method of claim 1, further comprising:
receiving an item context of the item, a first user profile of the first user, and a second user profile of the second user;
receiving, from the first user device, one or more first flexibility metrics of the first user for one or more aspects of the item;
receiving, from the second user device, one or more second flexibility metrics of the second user for the one or more aspects of the item;
generating, using a machine learning logic, an input suggestion for the first aspect of the item based on
the item context of the item,
the first user profile of the first user, the second user profile of the second user,
the one or more first flexibility metrics of the first user, and
the one or more second flexibility metrics of the second user; and
transmitting, to the first user device and the second user device for displaying to the first user and the second user, the input suggestion for the first aspect of the item.

8. The method of claim 1, further comprising:
responsive to determining that the first user input of the first user for the first aspect of the item does not overlap with the second user input of the second user for the first aspect of the item, determining, using a machine learning logic, a second aspect of the item based on the first aspect of the item;
receiving, from the first user device, a third user input of the first user for the first aspect of the item and a fourth user input of the first user for the second aspect of the item;
receiving, from the second user device, a fifth user input of the second user for the first aspect of the item and a sixth user input of the second user for the second aspect of the item;
determining that
the third user input of the first user for the first aspect of the item overlaps with the fifth user input of the second user for the first aspect of the item, and
the fourth user input of the first user for the second aspect of the item overlaps with the sixth user input of the second user for the second aspect of the item;
determining a different output value for the first aspect of the item based on the third user input of the first user and the fifth user input of the second user;
determining an output value for the second aspect of the item based on the fourth user input of the first user and the sixth user input of the second user; and
automatically generating the output object associated with the item, the output object including the different output value of the first aspect of the item and the output value for the second aspect of the item.

9. The method of claim 8, further comprising:
generating, using another machine learning logic, an input suggestion for the second aspect of the item based on an input suggestion for the first aspect of the item; and
transmitting, to the first user device and the second user device for displaying to the first user and the second user, the input suggestion for the second aspect of the item, wherein the first user device and the second user device displays the input suggestion for the second aspect of the item together with the input suggestion for the first aspect of the item.

10. A system comprising:
one or more processors; and
one or more memories storing instructions that, when executed by the one or more processors, cause the system to perform operations including:
receiving, from a first user device associated with a first user, a first user input for a first aspect of an item;
receiving, from a second user device associated with a second user, a second user input for the first aspect of the item;
determining whether the first user input of the first user for the first aspect of the item overlaps with the second user input of the second user for the first aspect of the item;
responsive to determining that the first user input of the first user for the first aspect of the item overlaps with the second user input of the second user for the first aspect of the item, determining an output value for the first aspect of the item based on the first user input of the first user and the second user input of the second user; and
automatically generating an output object associated with the item, the output object including the output value of the first aspect of the item.

11. The system of claim 10, wherein automatically generating the output object associated with the item includes:
retrieving an object template of the output object associated with the item; and
populating the object template of the output object with the output value of the first aspect of the item.

12. The system of claim 10, wherein determining that the first user input of the first user overlaps with the second user input of the second user includes one or more of:
determining that the first user input of the first user matches the second user input of the second user, the first user input and the second user input being selected from a plurality of predefined inputs associated with the first aspect of the item; and
determining that the first user input of the first user includes at least a portion of the second user input of the second user, the first user input and the second user input being a value range selected for the first aspect of the item.

13. The system of claim 10, wherein determining the output value for the first aspect of the item includes:
determining a threshold value of the first user input for the first aspect of the item;
determining a threshold value of the second user input for the first aspect of the item;
computing a difference value between the threshold value of the first user input and the threshold value of the second user input;
determining that the difference value between the threshold value of the first user input and the threshold value of the second user input does not satisfy a difference threshold; and
computing, using a machine learning logic, the output value for the first aspect of the item based on an item context of the item, the threshold value of the first user input, and the threshold value of the second user input.

14. The system of claim 10, wherein one or more processors are configured to perform the operations including:
receiving an item context of the item, a first user profile of the first user, and a second user profile of the second user;
receiving, from the first user device, one or more first flexibility metrics of the first user for one or more aspects of the item;
receiving, from the second user device, one or more second flexibility metrics of the second user for the one or more aspects of the item;
generating, using a machine learning logic, an input suggestion for the first aspect of the item based on
the item context of the item,
the first user profile of the first user, the second user profile of the second user,
the one or more first flexibility metrics of the first user, and
the one or more second flexibility metrics of the second user; and
transmitting, to the first user device and the second user device for displaying to the first user and the second user, the input suggestion for the first aspect of the item.

15. The system of claim 10, wherein one or more processors are configured to perform the operations including:
responsive to determining that the first user input of the first user for the first aspect of the item does not overlap with the second user input of the second user for the first aspect of the item, determining, using a machine learning logic, a second aspect of the item based on the first aspect of the item;
receiving, from the first user device, a third user input of the first user for the first aspect of the item and a fourth user input of the first user for the second aspect of the item;
receiving, from the second user device, a fifth user input of the second user for the first aspect of the item and a sixth user input of the second user for the second aspect of the item;
determining that
the third user input of the first user for the first aspect of the item overlaps with the fifth user input of the second user for the first aspect of the item, and
the fourth user input of the first user for the second aspect of the item overlaps with the sixth user input of the second user for the second aspect of the item;
determining a different output value for the first aspect of the item based on the third user input of the first user and the fifth user input of the second user;
determining an output value for the second aspect of the item based on the fourth user input of the first user and the sixth user input of the second user; and
automatically generating the output object associated with the item, the output object including the different output value of the first aspect of the item and the output value for the second aspect of the item.

16. The system of claim 15, wherein one or more processors are configured to perform the operations including:
generating, using another machine learning logic, an input suggestion for the second aspect of the item based on an input suggestion for the first aspect of the item; and
transmitting, to the first user device and the second user device for displaying to the first user and the second user, the input suggestion for the second aspect of the item, wherein the first user device and the second user device displays the input suggestion for the second aspect of the item together with the input suggestion for the first aspect of the item.

17. A method comprising:
receiving, at a computing device from a first user device, a first value range, the first user device being associated with a first user and distinct from the computing device;
receiving, at the computing device from a second user device, a second value range, the second user device being associated with a second user and distinct from the computing device;
determining, at the computing device, an overlap range between a threshold value of the first value range and a threshold value of the second value range;
determining, at the computing device, an output value in the overlap range based on the threshold value of the first value range and the threshold value of the second value range; and
transmitting, from the computing device to the first user device and the second user device, the output value.

18. The method of claim 17, wherein:
the output value in the overlap range satisfies a predefined ratio relative to the threshold value of the first value range and the threshold value of the second value range that are associated with the overlap range.

19. The method of claim 17, wherein determining the output value in the overlap range includes:
determining that the overlap range does not satisfy a difference threshold; and
computing, using a machine learning logic, the output value in the overlap range based on an item context of an item associated with the first value range and the second value range, the threshold value of the first value range, and the threshold value of the second value range.

20. The method of claim 17, further comprising:
receiving an item context of an item associated with one or more of the first value range and the second value range, a first user profile of the first user, and a second user profile of the second user;
receiving, from the first user device, one or more first flexibility metrics of the first user for one or more aspects of the item;
receiving, from the second user device, one or more second flexibility metrics of the second user for the one or more aspects of the item;
generating, using a machine learning logic, a value range suggestion for a first aspect of
the item from the one or more aspects of the item based on
the item context of the item,
the first user profile of the first user, the second user profile of the second user,
the one or more first flexibility metrics of the first user, and
the one or more second flexibility metrics of the second user; and
transmitting, to the first user device and the second user device for displaying to the first user and the second user, the value range suggestion for the first aspect of the item.
